(19) United States
(12) Patent Application Publication
(10) Pub. No.: US 2026/0146858 A1
(43) Pub. Date: May 28, 2026

(54) SYSTEMS AND METHODS INVOLVING PRESENTING NAVIGATION INSTRUCTIONS BASED ON IMAGE DATA

(71) Applicant: Apple Inc., Cupertino, CA (US)

(72) Inventors: Darius A. SATONGAR, Staffordshire (GB); Joseph A. MALIA, Kingston upon Thames (GB)

(21) Appl. No.: 19/336,110

(22) Filed: Sep. 22, 2025

Related U.S. Application Data
(60) Provisional application No. 63/700,043, filed on Sep. 27, 2024.

(51) Int. Cl. G01C 21/36; G06V 20/20

(52) U.S. Cl. CPC G01C 21/3602; G01C 21/3629; G06V 20/20

(57) ABSTRACT

An electronic device presents navigation instructions based on image data detected by cameras of the electronic device. An electronic device presents navigation instructions at different times based on certain criteria being satisfied, such as criteria relating to whether certain objects are in the field of view of the user at different times.

### CROSS REFERENCE TO RELATED APPLICATIONS

This application claims the benefit of U.S. Provisional Application No. 63/700,043, filed Sep. 27, 2024, the entire disclosure of which is herein incorporated by reference for all purposes.

### FIELD OF THE DISCLOSURE

This disclosure relates generally to an electronic device presenting navigation instructions.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to perform mathematical operations. The user may therefore desire efficient ways of performing mathematical operations.

### SUMMARY OF THE DISCLOSURE

In some cases, while using a navigation application of an electronic device, directional instructions of the route are presented in a user interface in a list format. In some cases, while using a navigation application, directional instructions are displayed in a map user interface where the route is highlighted on the map (e.g., predetermined navigation instructions are displayed on a screen of a mobile phone). However, when an electronic device is navigating a user along a route, the user may look in different directions and/or objects can be observed by the user along the route that are not identified in the navigation instructions that are presented by the navigation application. Thus, a navigation application that detects objects along a route as the user travels along the route and that presents navigation instructions relative to those objects enhances electronic-based navigation. In some of the present embodiments, an electronic device presents navigation instructions based on image data detected by cameras of the electronic device. In some of the present embodiments, the electronic device uses an image recognition system that is trained to recognize objects in image data for use with navigation instructions. In some of the present embodiments, navigation instructions are presented at different times based on certain criteria being satisfied, such as criteria relating to whether certain objects are in the field of view of the user at different times. In this way, electronic-based navigations become more efficient and less cumbersome.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6Q generally illustrate examples of an electronic device presenting navigation instructions relative to certain objects detected by cameras at the location of the electronic device, and further generally illustrate examples of an electronic device presenting navigation instructions at different times based on when certain criteria are satisfied in accordance with some embodiments.

FIG. 7 illustrates a flow diagram illustrating a method for presenting navigation instructions relative to recognized objects in response to detecting image data that includes the recognized objects in accordance with some embodiments of the disclosure.

FIG. 8 illustrates a flow diagram illustrating a method for presenting navigation instructions at different times based on when certain criteria are satisfied in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

In some cases, while using a navigation application of an electronic device, directional instructions of the route are presented in a user interface in a list format. In some cases, while using a navigation application, directional instructions are displayed in a map user interface where the route is highlighted on the map (e.g., predetermined navigation instructions are displayed on a screen of a mobile phone). However, when an electronic device is navigating a user along a route, the user may look in different directions and/or objects can be observed by the user along the route that are not identified in the navigation instructions that are presented by the navigation application. Thus, a navigation application that detects objects along a route as the user travels along the route and that presents navigation instructions relative to those objects enhances electronic-based navigation. In some of the present embodiments, an electronic device presents navigation instructions based on image data detected by cameras of the electronic device. In some of the present embodiments, the electronic device uses an image recognition system that is trained to recognize objects in image data for use with navigation instructions. In some of the present embodiments, navigation instructions are presented at different times based on certain criteria being satisfied, such as criteria relating to whether certain objects are in the field of view of the user at different times. In this way, electronic-based navigations become more efficient and less cumbersome.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not).

Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

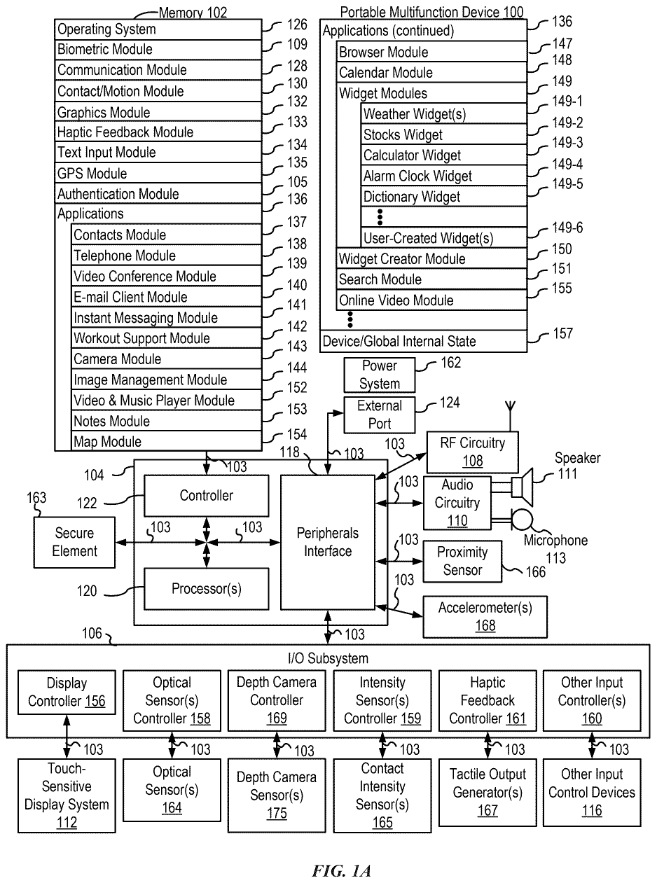

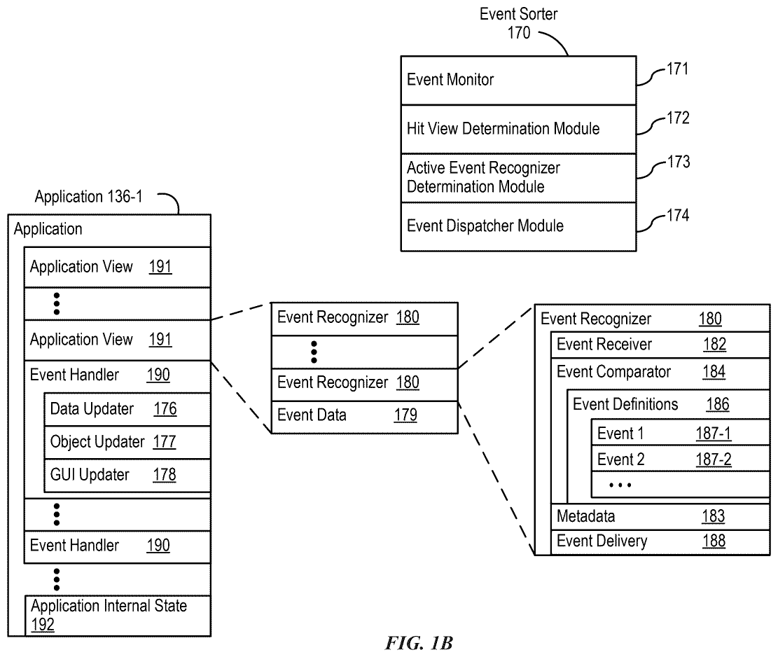

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124.

Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves.

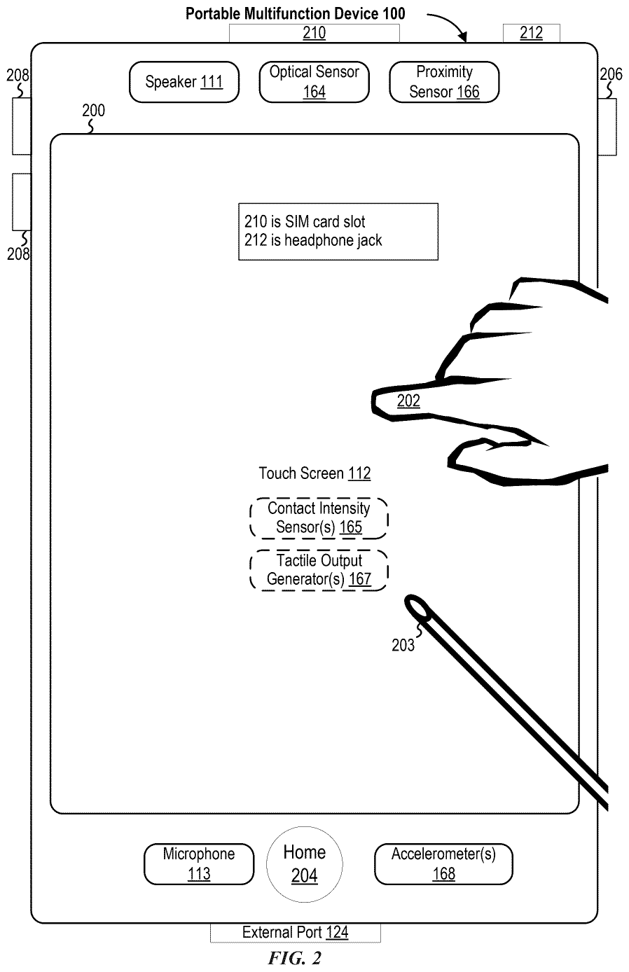

Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; U.S. Ser. No. 11/240,788, “Proximity Detector In Handheld Device”; U.S. Ser. No. 11/620,702, “Using Ambient Light Sensor To Augment Proximity Sensor Output”; U.S. Ser. No. 11/586,862, “Automated Response To And Sensing Of User Activity In Portable Devices”; and U.S. Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

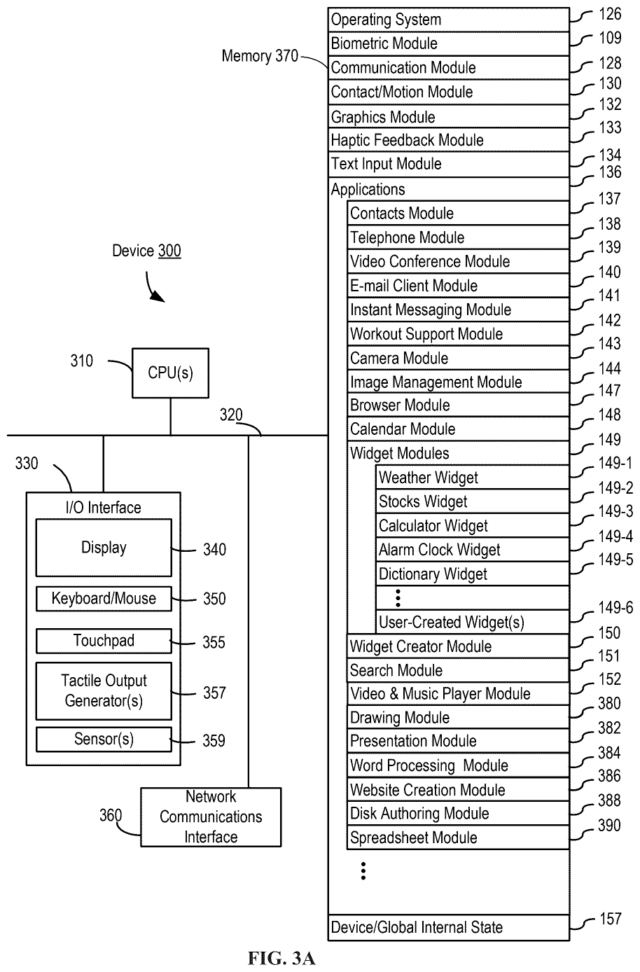

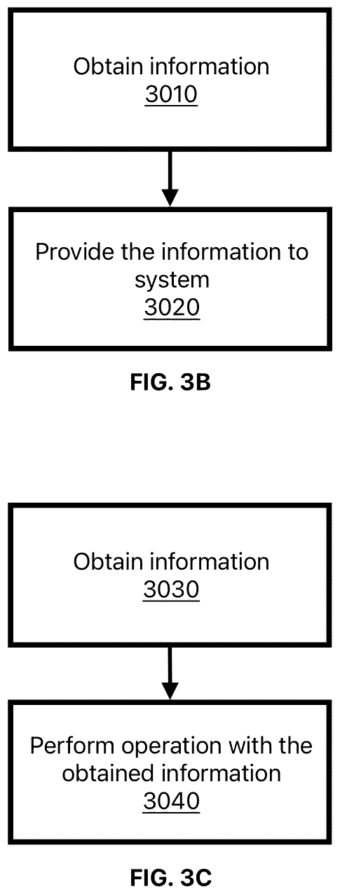

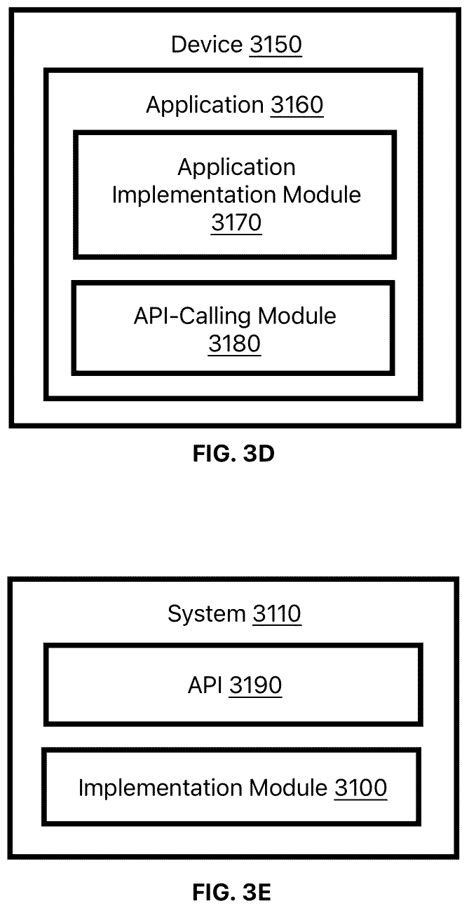

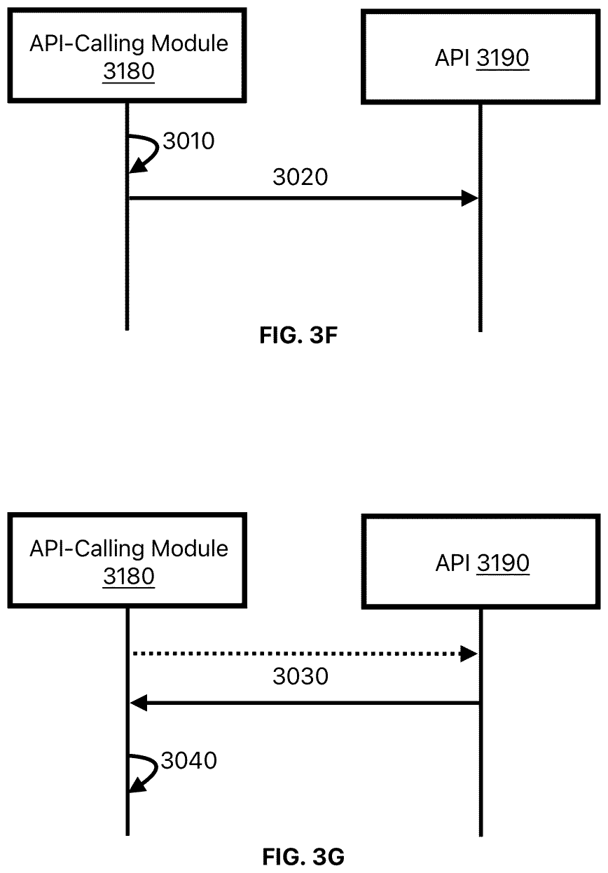

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as Vx Works) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware.

Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Ser. No. 60/936,562 , “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others.

In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100.

Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

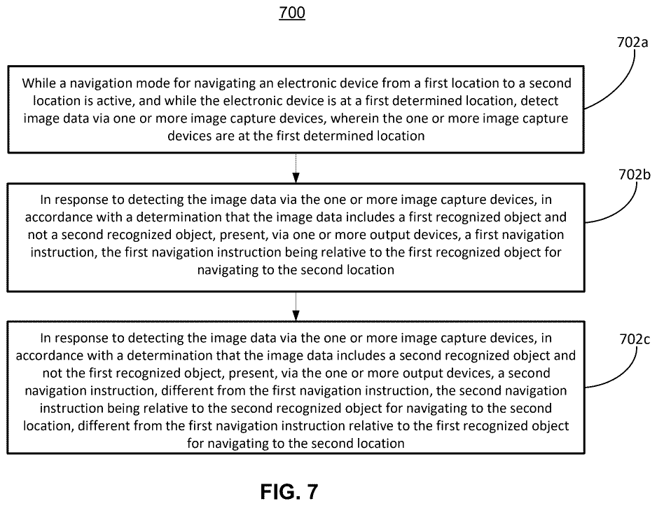

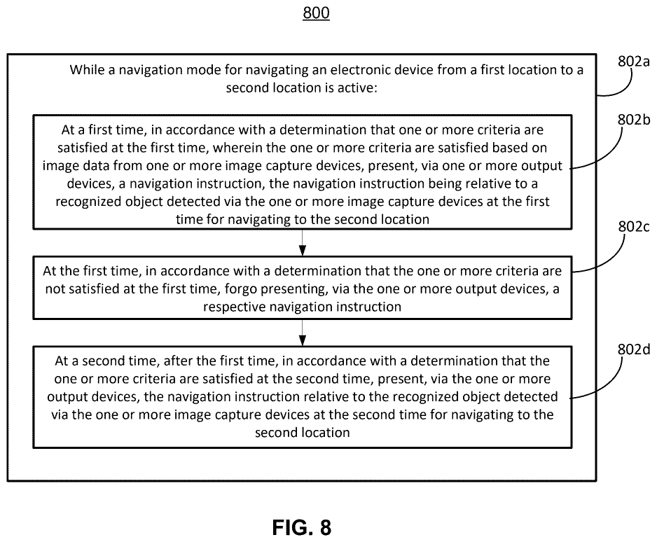

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and 800 (FIGS. 7 and 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

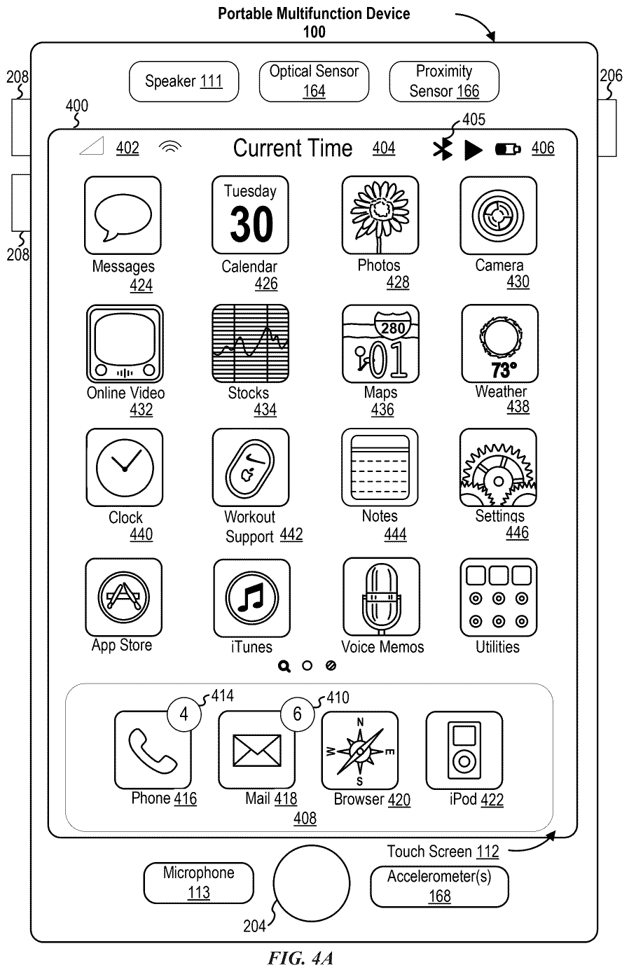

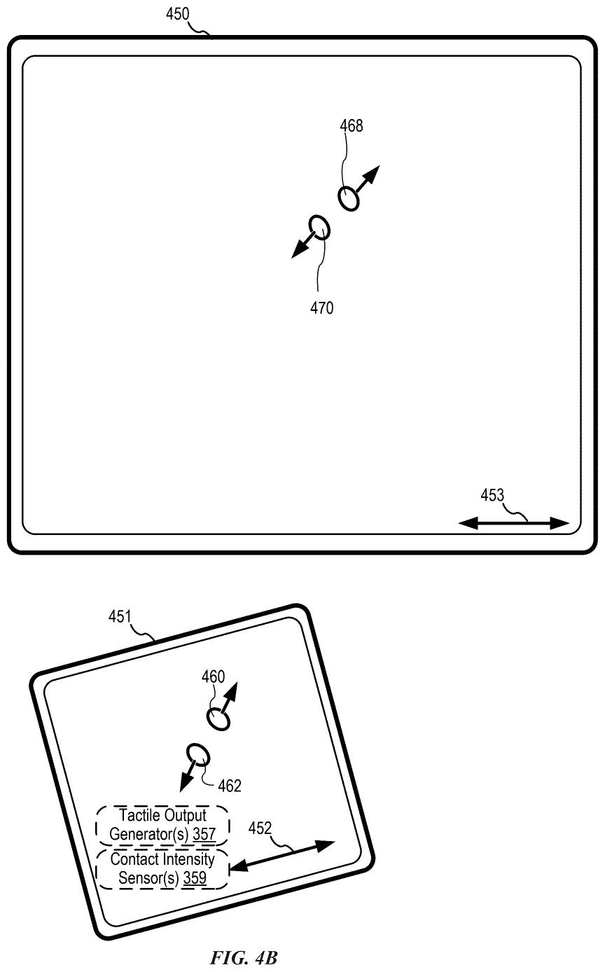

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIGS. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

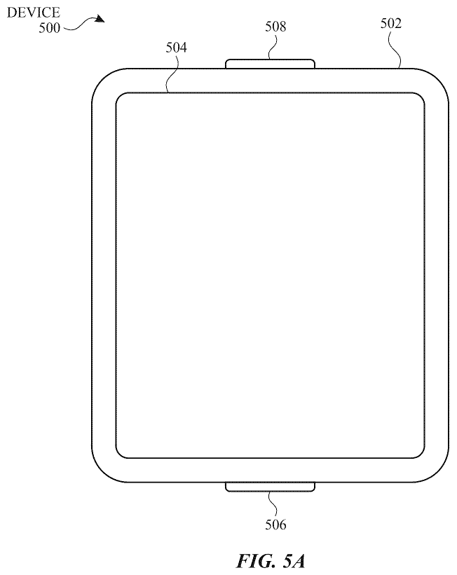

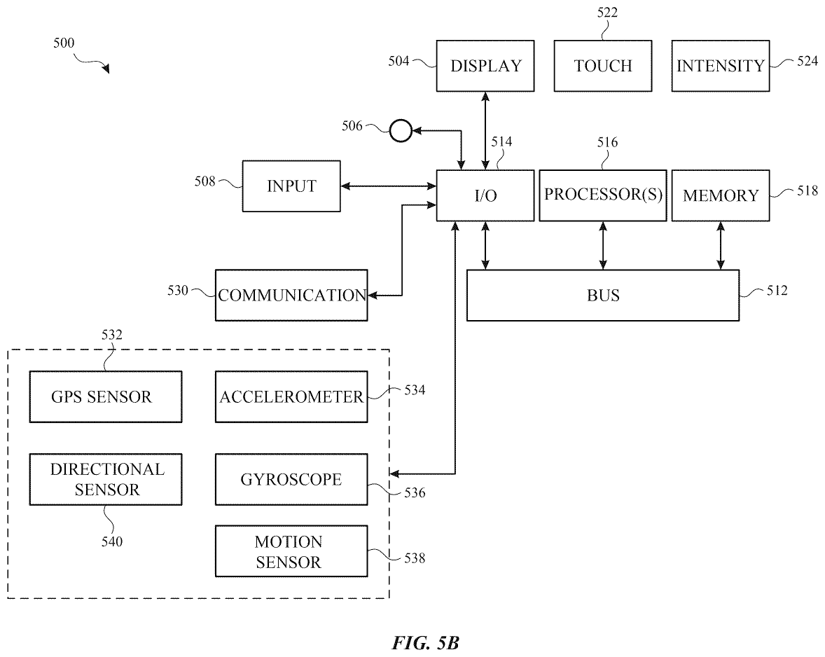

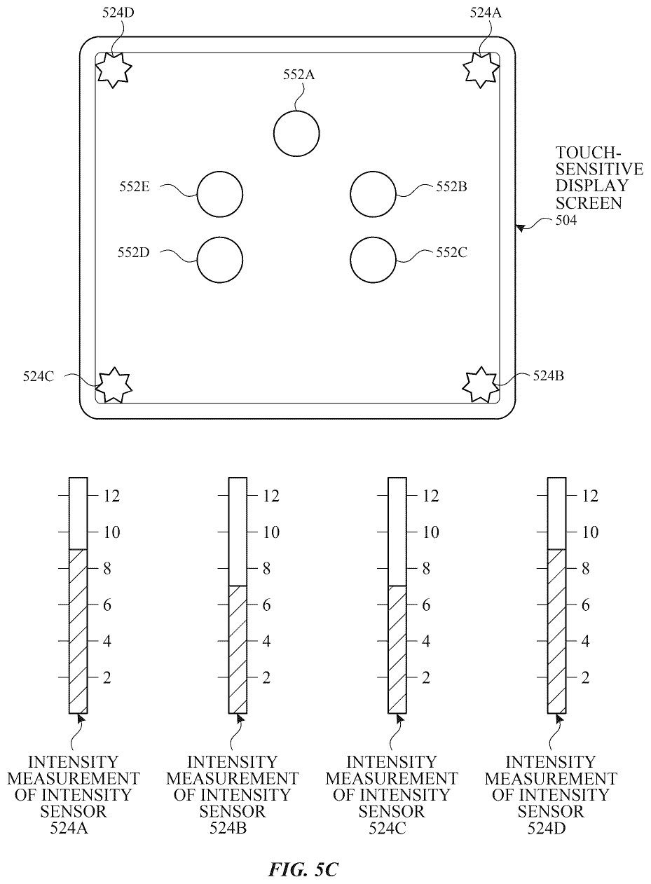

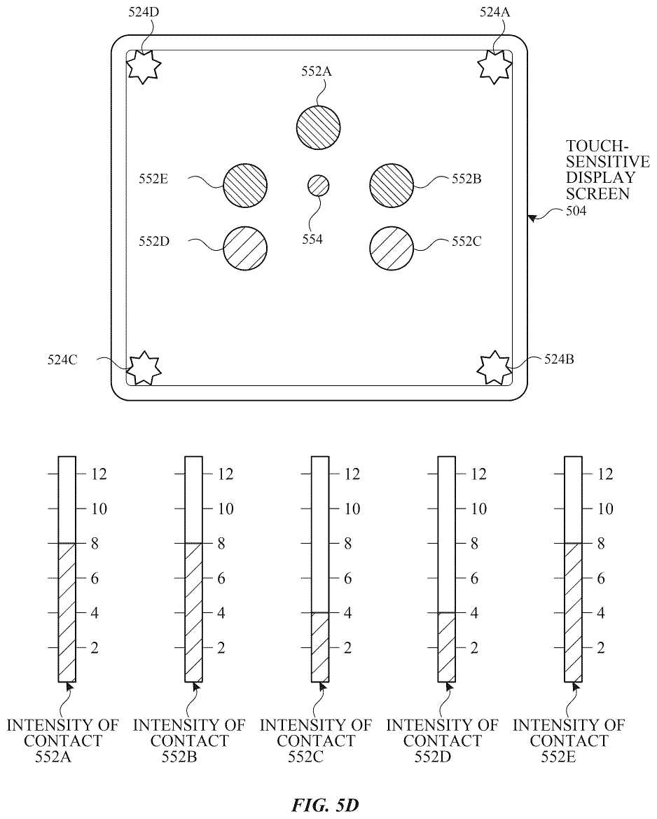

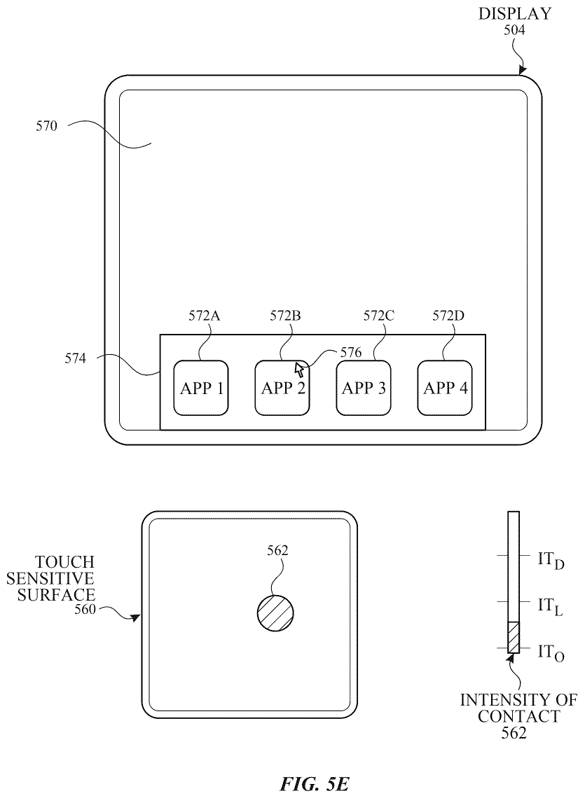

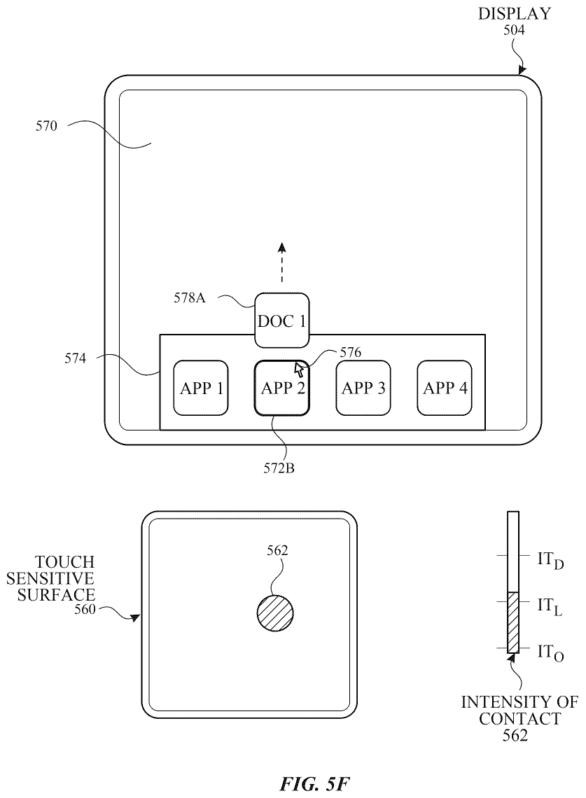

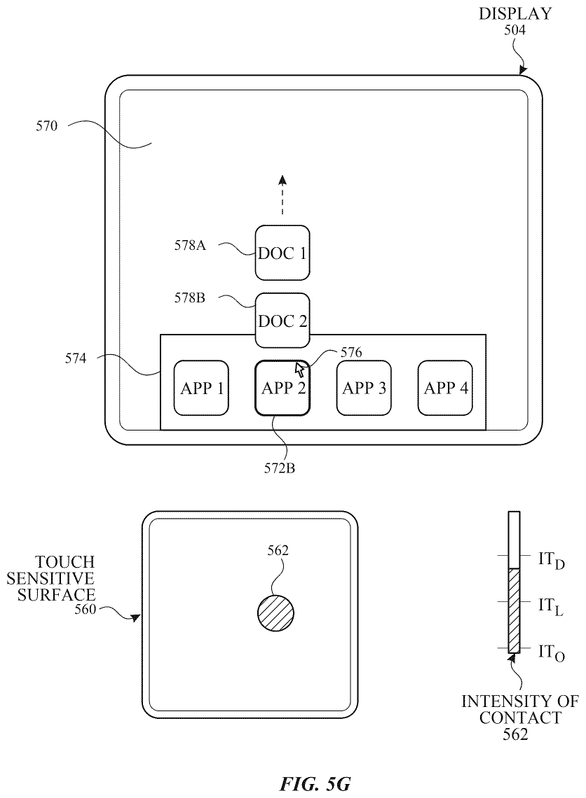

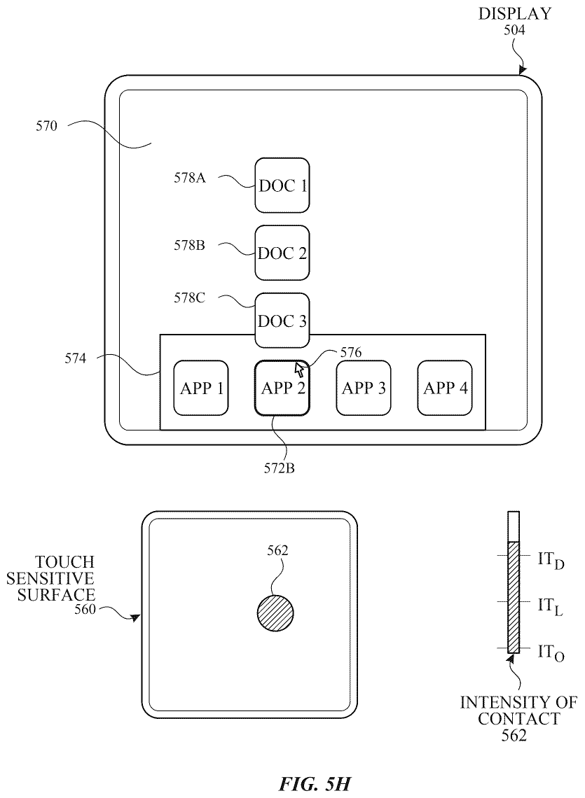

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700 and/or 800). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

Users interact with electronic devices in many different manners. Sometimes users engage electronic devices for assistance with navigating to a destination. For example, icon 436 of FIG. 4A is optionally selectable by a user for viewing a map application (e.g., a navigation application). Note that when a person uses a device, that person is optionally referred to as a user of the device.

In some cases, while using a navigation application of an electronic device, directional instructions of the route are presented in a user interface in a list format. In some cases, while using a navigation application, directional instructions are displayed in a map user interface where the route is highlighted on the map (e.g., predetermined navigation instructions are displayed on a screen of a mobile phone). However, when an electronic device is navigating a user along a route, the user may look in different directions and/or objects can be observed by the user along the route that are not identified in the navigation instructions that are presented by the navigation application. Thus, a navigation application that detects objects along a route as the user travels along the route and that presents navigation instructions relative to those objects enhances electronic-based navigation. In some of the present embodiments, an electronic device presents navigation instructions based on image data detected by cameras of the electronic device. In some of the present embodiments, the electronic device uses an image recognition system that is trained to recognize objects in image data for use with navigation instructions. In some of the present embodiments, navigation instructions are presented at different times based on certain criteria being satisfied, such as criteria relating to whether certain objects are in the field of view of the user at different times. In this way, electronic-based navigations become more efficient and less cumbersome.

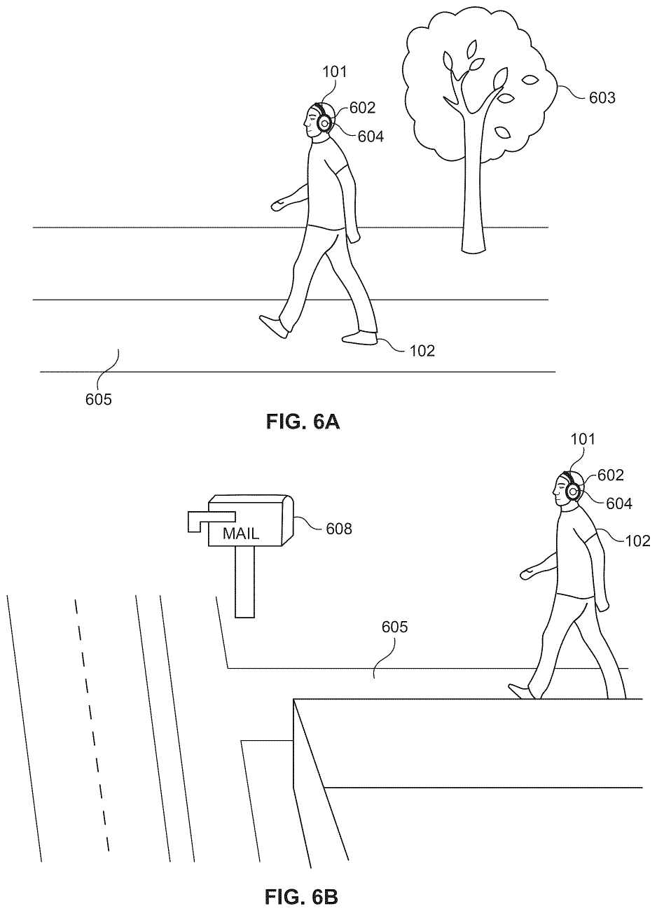

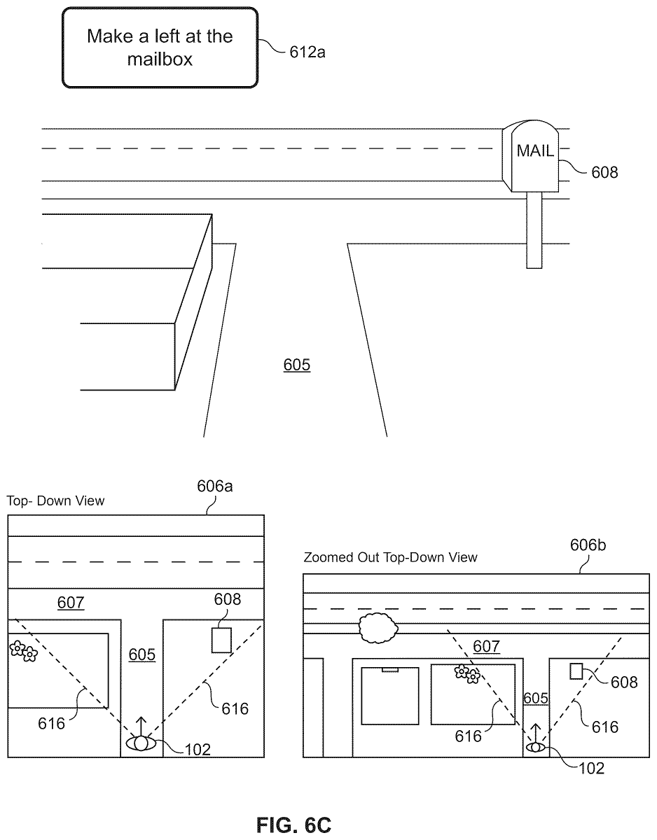

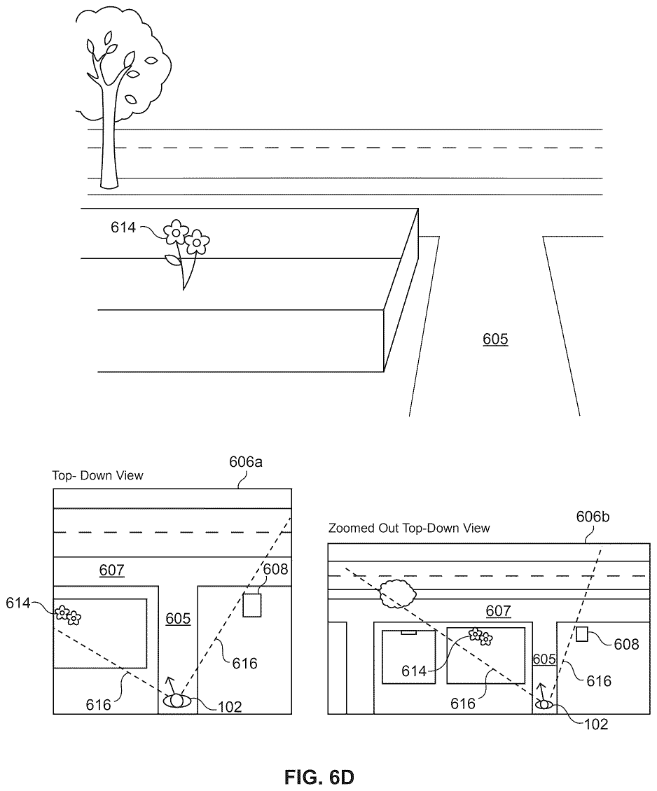

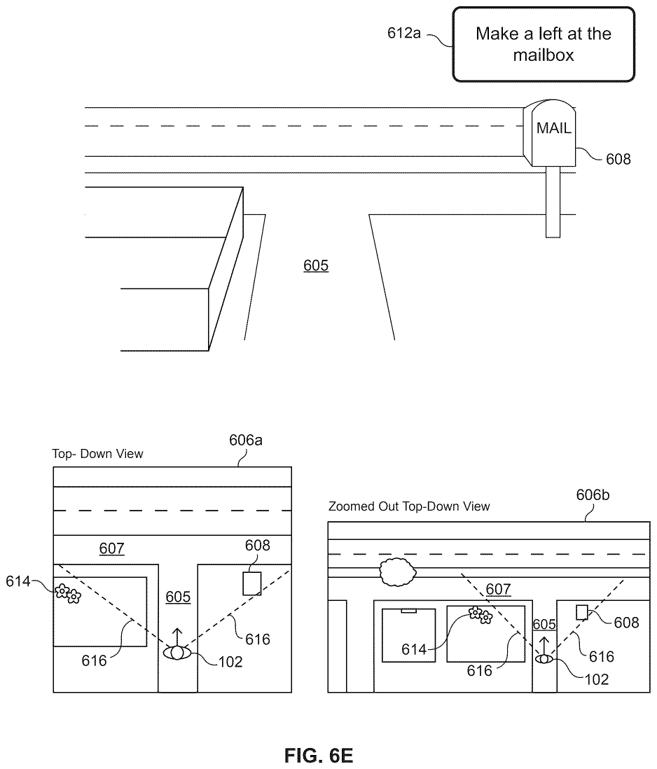

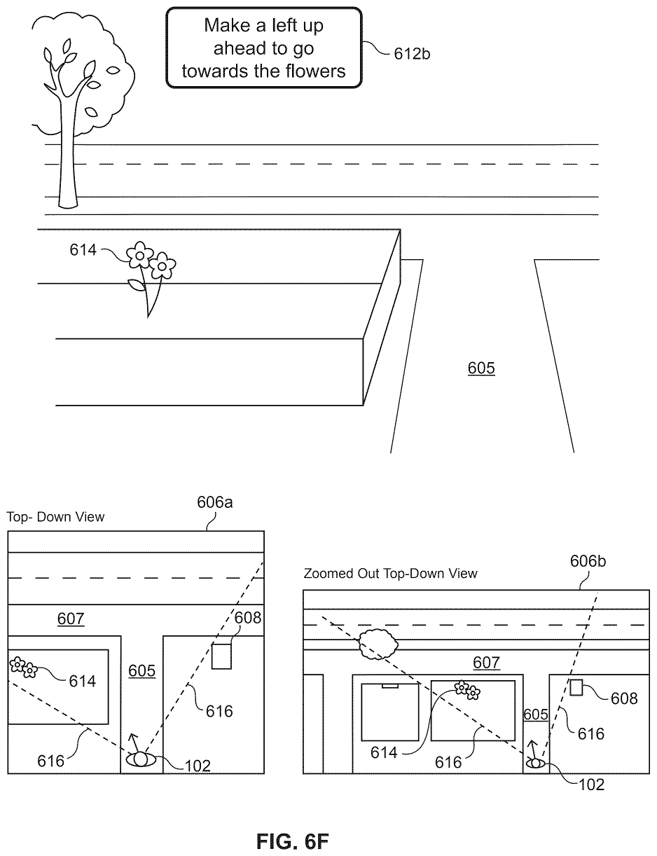

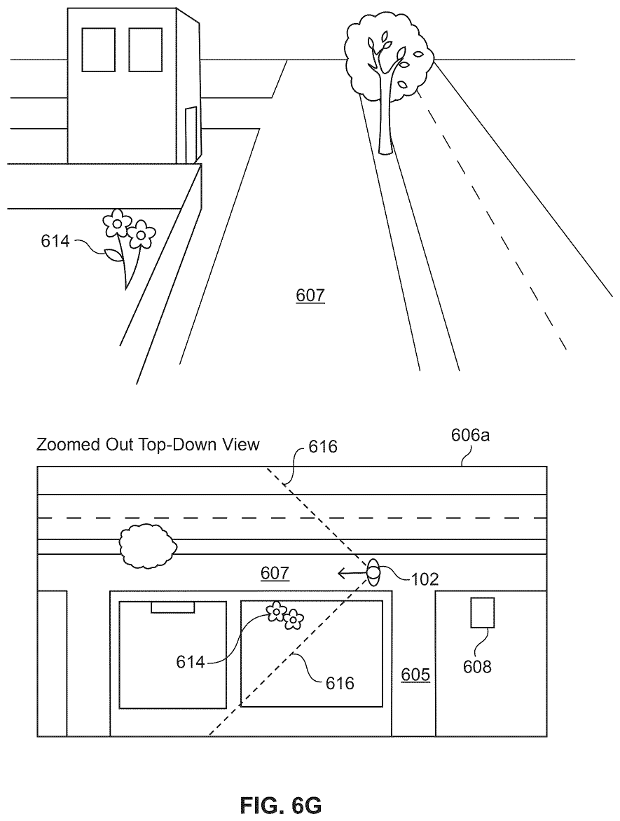

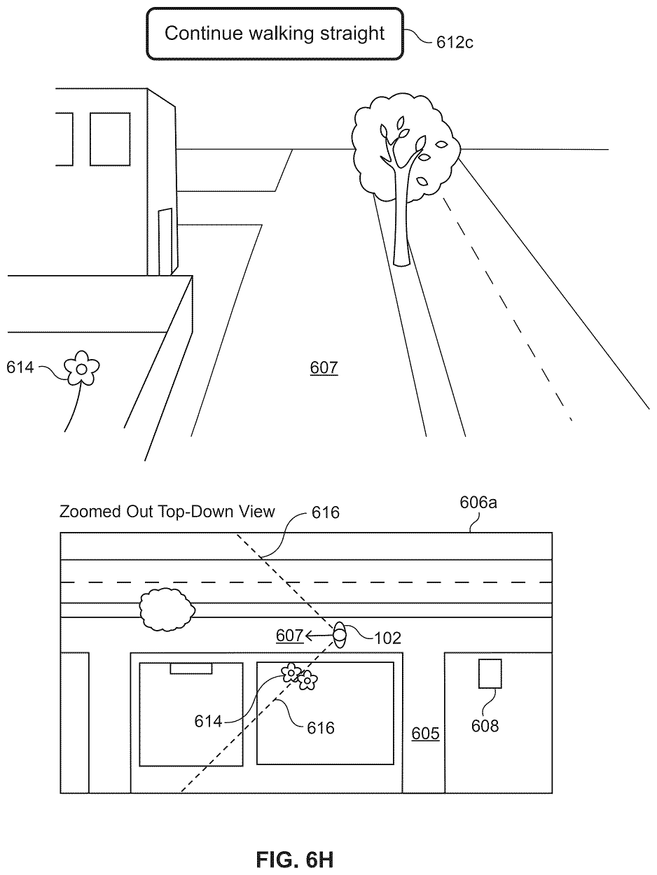

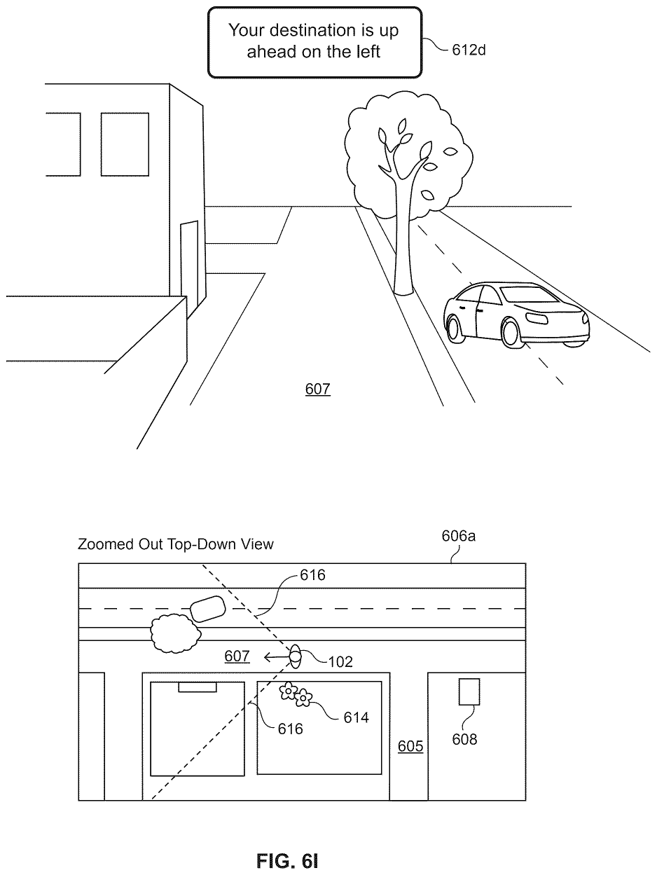

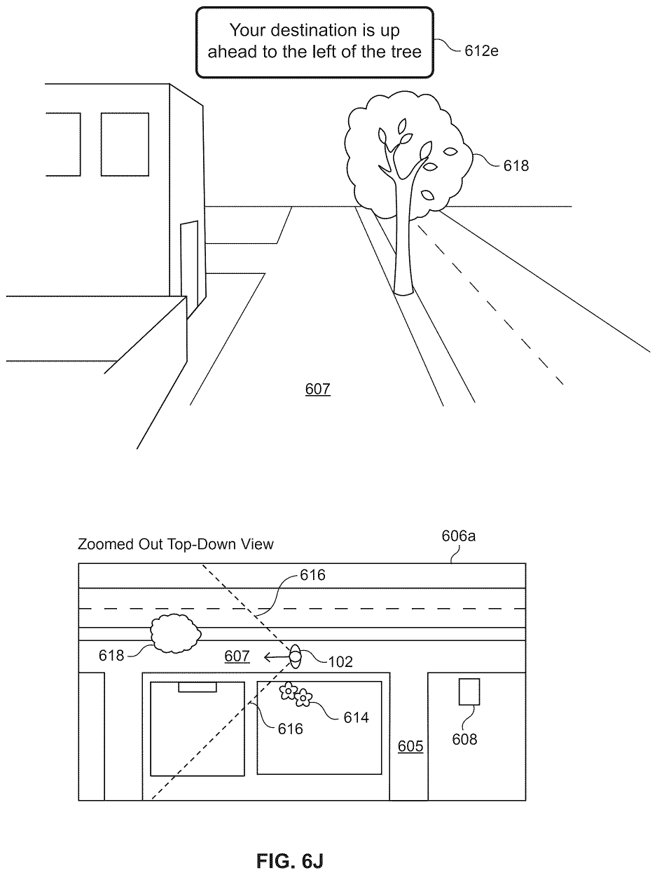

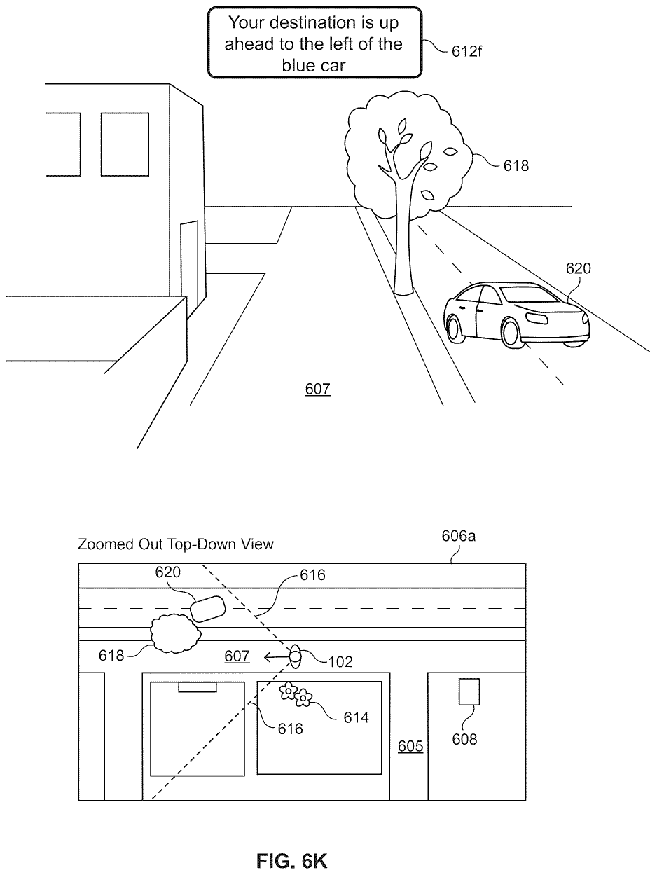

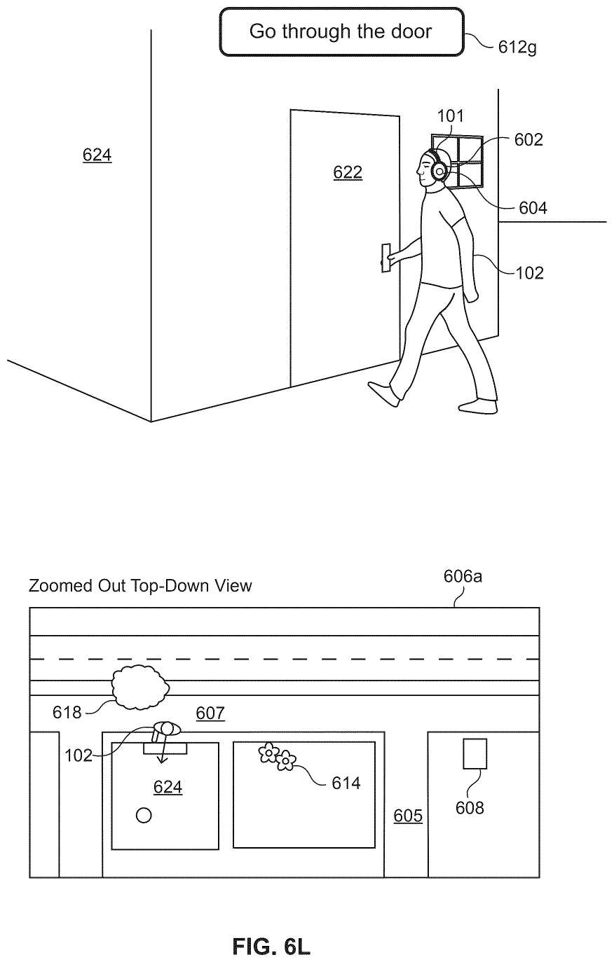

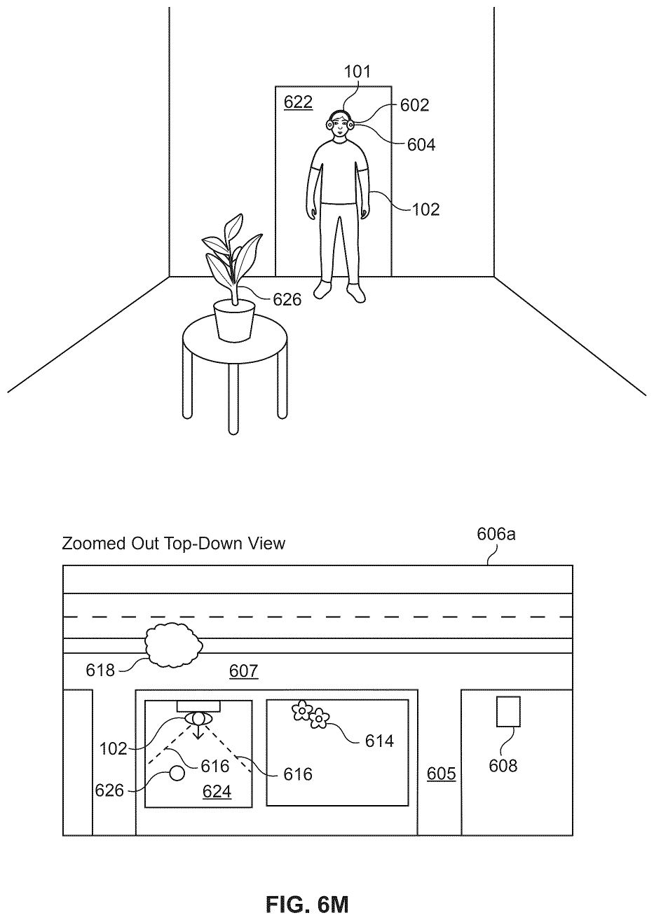

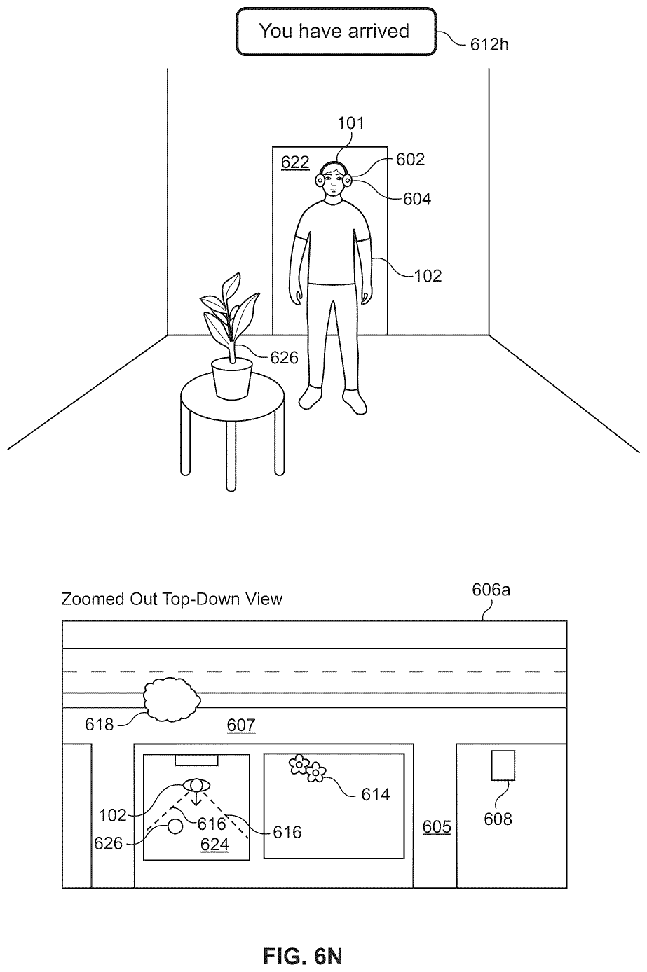

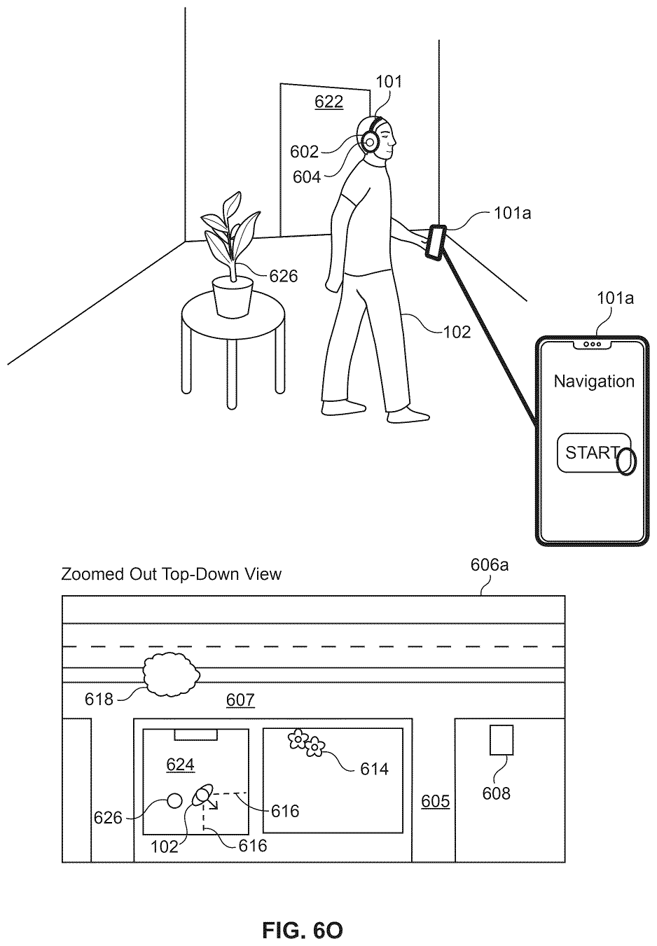

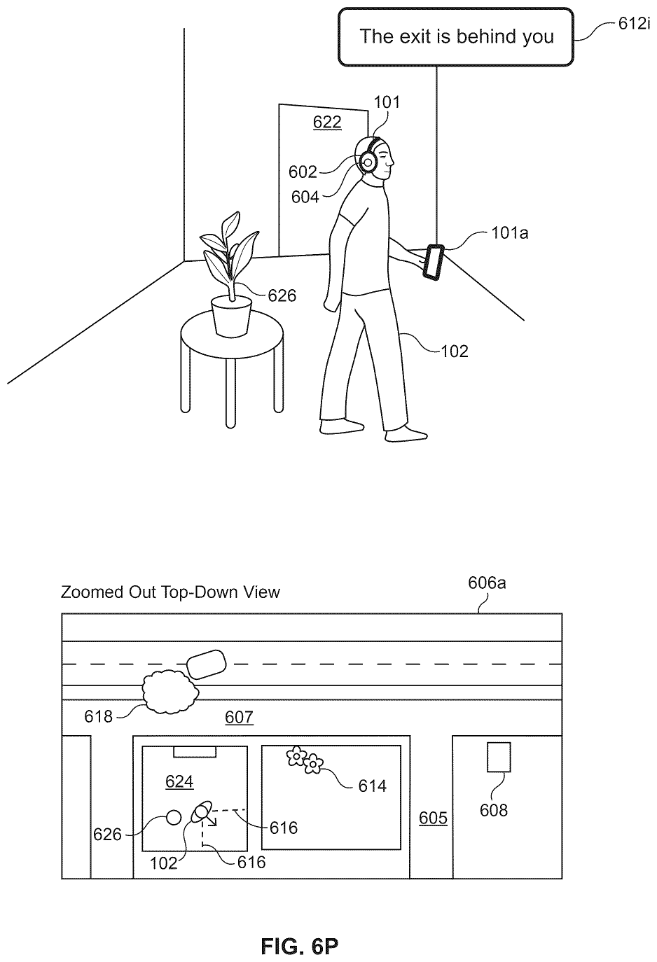

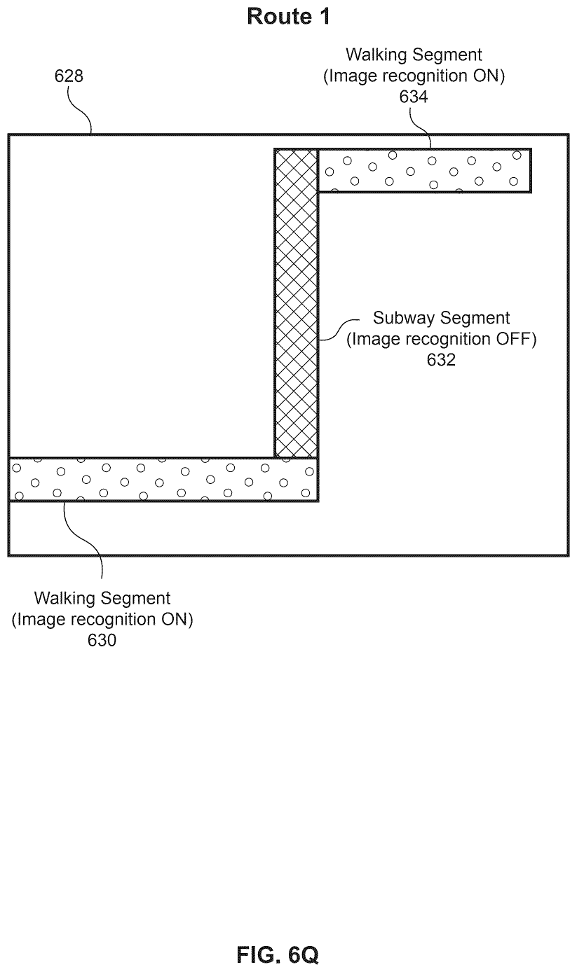

FIGS. 6A-6Q generally illustrate examples of an electronic device presenting navigation instructions relative to certain objects detected by cameras at the location of the electronic device, and further, generally illustrate examples of an electronic device presenting navigation instructions at different times based on when certain criteria are satisfied in accordance with some embodiments. The embodiments illustrated in these figures also show examples of certain features of the embodiment(s) of methods 700 and 800.

FIG. 6A illustrates a perspective view of a user 102 of electronic device 101 walking along a path (e.g., a segment 605 of a route to a destination), which is part of a route determined by the electronic device 101 for navigating the user 102 from a first location to a destination location. In FIG. 6A, the user 102 has just walked by a tree 603, and is continuing walking (e.g., leftward in the illustrated embodiment).

In FIG. 6A, the electronic device 101 is being worn by the user 102 (e.g., is being worn on the head of the user 102). In FIG. 6A, the electronic device 101 includes cameras 602 that detect image data from a location of the electronic device 101 and includes headphones 604 as presentation components for presentation navigation instructions to the user 102 via audio. In FIG. 6A, the cameras 602 are being worn on the head of the user 102 and are pointing outward toward the direction that the head of the user 102 is facing such that the field of view of the cameras overlap the field of view of the forward-head direction of the user 102. In some embodiments, the cameras 602 face the forward head direction of the user of the electronic device 101. In some embodiments, the cameras 602 are worn on the head, ears, torso, or another portion of the user. In some embodiments, the electronic device 101 is a system that includes cameras (e.g., cameras 602), headphones (e.g., headphones 604) that present audio-based navigation instructions, and a cell phone that presents display-based navigation instructions, where one or more of the cameras, headphones, and the cell phone are part of different devices and/or are physically coupled to the same device (e.g., the same housing). For example, the electronic device 101 is optionally in communication with another device, such as device 101a of FIG. 60, which is optionally a mobile phone with a touch screen. In some embodiments, device 101a performs one or more processing operations and transmits commands to the electronic device 101, such as commands to present navigation instructions to the user 102. In some embodiments, the electronic device 101 includes an augment reality / virtual reality display system. Further description of the electronic device 101 are provided with reference to methods 700 and 800. In some embodiments, the electronic device 101 tracks its location via one or more location tracking systems, such as Global Positioning System (GPS), geofencing, and/or another location tracking system. For example, the location of the electronic device 101 is optionally tracked via GPS tracking of the device 101a.

FIG. 6B shows another perspective view of the electronic device 101 after having been moved along the determined route closer to a next segment of the route (e.g., in FIG. 6B the electronic device 101 is closer to segment 607 of FIG. 6C than it was in FIG. 6A). That is, from FIG. 6A to 6B, the electronic device 101 was optionally being moved (e.g., in accordance with the walking of the user 102) along the same segment of the route, and now, in FIG. 6B, the electronic device 101 is within a threshold distance (e.g., 0.5 m, 1 m, 2 m, 5 m, 10 m, or 20 m, 25 m, 50 m, or another threshold distance) of a next segment of the route.

FIG. 6C shows a perspective 610a (e.g., that which is in the viewpoint of the user, in the field of view, and/or in the range of sight) of the user 102 of the electronic device 101 and shows a field of view 616 of the cameras 602 of the electronic device 101 while the electronic device is at the illustrated position of FIG. 6B. FIG. 6C further includes a top-down view 606a and a zoomed out top-down view 606b, each of which includes the angular extent of the field of view 616 of the of the cameras 602, which optionally overlaps, is the same as, is greater than, or is less than the angular extent of the field of view of the user 102 of the electronic device 101.

As shown in FIG. 6C, mailbox 608 is in the field of view 616 of the cameras 602. In response to detecting mailbox 608, the electronic device 101 presents a navigation instruction 612a that is relative to mailbox 608. In FIG. 6C, navigation instruction 612a is optionally verbally communicated via the headphones of the electronic device 101. For example, in FIG. 6C, the electronic device 101 optionally verbally indicates “Make a left at the mailbox.” In FIG. 6C, the navigation instruction 612a identifies a navigation maneuver and a location that the maneuver is to be made. For example, navigation instruction 612a indicates make a left, which is the navigation maneuver, and indicates “at the mailbox”, which is the location that the maneuver is to be made, which is at the mailbox 608 identified by the electronic device 101 via the cameras 602. Thus, in FIG. 6C, the electronic device 101 is directing the user using objects that it recognizes in the field of view 616 of the cameras, which in the illustrated embodiment, overlaps with the perspective 610a of the user 102 of the electronic device 101. For example, the maps/ navigation application of the electronic device 101 optionally does not have prior knowledge that the mailbox 608 is at the next segment of the route, but optionally obtains such knowledge during processing of image data from the cameras 602. In this way, even temporary and/or non-traffic orienting signs or objects (e.g., strollers, skateboards, chairs, and/or other objects) can be identified in the image data detected by the cameras 602 and used in navigation instructions presented by the electronic device 101. Further descriptions of types of objects that can be identified in the image data detected by the cameras 602 are described with reference to embodiment(s) of methods 700 and 800. Additionally, in FIG. 6C, the electronic device 101 presents navigation instruction 612a as spatialized audio being simulated as emanating from the location of the maneuver that is to be made at the mailbox 608. That is, in FIG. 6C the navigation instruction 612a is presented as emanating from a location that is leftward of the mailbox 608, which corresponds to the leftward maneuver that is to be made at the mailbox 608. Thus, in some embodiments, the electronic device presents navigation instructions differently based on the location of the maneuver that is to be made at the recognized object. Further discussion about the presentation of navigation instructions as spatialized audio is provided with reference to embodiment(s) of method 700.

FIG. 6D illustrates an alternative case of an electronic device forgoing presenting a navigation instruction due to certain criteria being met while the electronic device is within the threshold distance of the next segment of the route in accordance with some embodiments. More particularly, FIG. 6D shows an alternative example of the electronic device 101 being moved from its location in FIG. 6A to its location in FIG. 6B, which is within the threshold distance of the next segment of the route, but without having detected a recognized object in the field of view of the cameras 602 (e.g., without having detected mailbox 608). For example, as shown in the top-down views 606a and 606b in FIG. 6D, the field of view of the cameras 602 does not include mailbox 608. As such, though the electronic device 101 has been moved along the same route to the same location as in FIG. 6C, the electronic device 101 does not present the navigation instruction 612a because the cameras 608 has not detected the mailbox 608 (e.g., while within the threshold distance), and/or because the mailbox 608 is not in the perspective of the user.

FIG. 6E illustrates an alternative case of an electronic device presenting navigation instruction 612a in response to detecting that image data detected by the cameras 602 include mailbox 608 after having not presented navigation instruction 612a at its location in FIG. 6D in accordance with some embodiments. In some embodiments, navigation instruction 612a in FIG. 6E includes one or more different characteristics than navigation instruction 612a in FIG. 6C. For example, navigation instruction 612a in FIGS. 6C and 6E optionally identify a distance to the maneuver that is to be made at the mailbox 608, and since the distance from the electronic device 101 to the mailbox 608 is different in FIGS. 6C and 6E, the navigation instruction 612a that is presented at these different locations optionally indicate the respective distance that is to the mailbox 608 from the respective location that the navigation instruction is presented. For example, in FIG. 6E, navigation instruction 612a optionally verbally indicates “in 20 ft make a left at the mailbox”, which indicates a distance from the current location of the electronic device 101 (e.g., 20 ft) to the maneuver that is to be made at the mailbox 608 while in FIG. 6C, navigation instruction 612a optionally verbally indicates “in 40 ft make a left at the mailbox”, which indicates a distance from the current location of the electronic device 101 (e.g., 40 ft) to the maneuver that is to be made at the mailbox 608. Additionally, in FIG. 6E, the electronic device 101 presents navigation instruction 612a as spatialized audio being simulated as emanating from the location of the mailbox 608. Further discussion about the presentation of navigation instructions as spatialized audio is provided with reference to embodiments(s) of method 700.

FIG. 6F illustrates an alternative case of an electronic device presenting a navigation instruction 612b in response to detecting that image data detected by the cameras 602 include flowers 614. For example, in FIG. 6F, the electronic device 101 is optionally located at the same position as in FIG. 6D, and the electronic device 101 detects flowers 614 and not the mailbox 608, based on the direction that the user 102 is facing at that direction while the user 102 is traveling along the current segment of the route. In response to detecting the flowers 614, the electronic device 101 presents navigation instruction 612b, which identifies a maneuver that is to be made relative to the flowers 612. Thus, the electronic device 101 directs the user using objects that it recognizes in the field of view 616 of the cameras, which in the illustrated embodiment, includes the flowers 614 and not the mailbox 608. In some embodiments, navigation instruction 612b is presented as audio. Note that in some embodiments detection of particular objects triggers the action of presenting a navigation instruction relative to an object. For example, in FIG. 6D though the flowers 614 were in the field of view 616 of the cameras 602, the electronic device 101 did not present a navigation instruction relative to the flowers 614 in FIG. 6D optionally because the flowers 614 were not part of the set of objects that the electronic device 101 is configured to recognize in the embodiment illustrated in FIG. 6D. Also, note that in some embodiments the electronic device 101 can identify different types of objects.

FIG. 6G illustrates a view of cameras 602 after the electronic device 101 has been moved in accordance with the maneuver described with reference to FIGS. 6C, 6E, and 6F. That is, in FIG. 6G, the electronic device 101 has made the leftward maneuver, as suggested by the navigation instructions 612a/612b, relative to the mailbox 608. In some embodiments, the electronic device 101 toggles activation of the cameras based on a distance until a next maneuver. In some embodiments, the electronic device 101 toggles activation of the camera based on GPS data that indicates a distance until the next maneuver. For example, if the distance to a next maneuver is more than a threshold distance, the electronic device optionally maintains the cameras 602 in an off state, and if the distance to the next maneuver is less than the threshold distance, the electronic device 101 optionally maintains the cameras in an on state so that the cameras 602 can detect image data. By toggling the cameras 602, the electronic device 101 conserves its computing resources. In some embodiments, the cameras 602 in FIG. 6G are in an off state since a distance to a next maneuver (or next segment) in FIG. 6G is greater than a threshold distance. In some embodiments, the cameras 602 in FIG. 6G are in an on state, but the electronic device 101 is not presenting navigation instructions based on image data detected by the cameras 602.

FIG. 6H illustrates an electronic device presenting navigation instruction 612c in response to detecting that a threshold amount of time has passed since a navigation instruction has been presented, in accordance with some embodiments.

In FIG. 6H, electronic device 101 presents a confirmation (e.g., navigation instruction 612c) that the electronic device 101 is being moved in the correct direction along the route to the destination. In some embodiments, this confirmation is presented after a threshold amount of time (e.g., 30 seconds, one minute, two minutes, three minutes, five minutes, or another threshold amount of time) since a previous navigation instruction has been presented. In some embodiments, this confirmation is presented without including or identifying objects in image data detected by the cameras 602. In some embodiments, this confirmation is presented with an identification of objects in image data detected by the cameras 602. For example, navigation instruction 612c optionally identifies a navigation maneuver to make relative to an identified object in the image data, such as the navigation instruction 612c instructing the user to continue walking straight past the flowers 614, which in the illustrated embodiment, is still in the view of the cameras 602. In some embodiments, navigation instruction 612c is presented without identifying an object in the image data captured by the cameras 602, such as shown in FIG. 6H. In some embodiments, navigation instruction 612c is presented without identifying an object in the image data because no recognized object is detected in the image data, such as flowers 614 not being in the field of view of the cameras 602. In some embodiments, navigation instruction 612c is presented in accordance with GPS data without being based on image data.

For example, the electronic device 101 optionally presents a navigation instruction that is not based on image data captured by the cameras 602, but based on GPS data, if, for example, no recognized object is detected by the cameras 602 when it is determined based on GPS data that a navigation instruction should be presented.

FIGS. 6I through 6K illustrate alternative embodiments of an electronic device presenting navigation instructions as the location of the electronic device approaches a destination of the navigation in accordance with some embodiments.

In FIG. 6I, the electronic device 101 presents navigation instruction 612d which identifies a location of the destination, without identifying a recognized object. In some embodiments, navigation instruction 612d further includes a distance indicator in the instruction, such as the navigation instruction 612 d indicating that the destination is 30 meters up ahead on the left. In some embodiments, navigation instruction 612d is presented because image data is not being detected by cameras 602 or because the electronic device 101 is unable at the illustrated time to identify objects in the image data. In some such cases, the electronic device 101 may present navigation instruction 612d. Further discussion of the electronic device presenting navigation instructions that are not based on image data detected by cameras 602 is provided with reference to embodiment(s) of methods 700 and 800.

In FIG. 6J, the electronic device 101 presents navigation instruction 612e, which includes an identification of an object in the image data detected by the cameras 602. In the illustrated case, the object is a tree 618, and the navigation instruction 612e identifies a location of the destination relative to the tree 618. Specifically, in the illustrated case, the navigation instruction 612e indicates that the destination of the navigation is ahead of the current location of the electronic device 101 (based on the forward direction of the electronic device 101, which in the illustrated case is the same direction that the user is facing) and is left of the tree 618. Thus, the electronic device 101 enhances navigation systems by utilizing image data to present navigation instructions that include navigation information identifying objects in the image data.

In FIG. 6K, the electronic device presents navigation instruction 612f, which includes an identification of an object in the image detected by the cameras 602. In the illustrated case, the object is the blue car 620, and the navigation instruction 612f identifies a location of the destination relative to the blue car 620. Specifically, in the illustrated case, the navigation instruction 612f indicates that the destination of the navigation is ahead of the current location of the electronic device based on the forward direction of the electronic device and is left of the blue car 620. Thus, the electronic device 101 enhances navigation systems by utilizing image data to present navigation instructions that include navigation information identifying objects in the image data. Additionally or alternatively, in some embodiments, were multiple objects detected in the image data, the electronic device 101 presents navigation instruction relative to the multiple objects, such as the navigation instruction 612f indicating that the destination is ahead and to the left of the tree 618 and the blue car 620. Additionally or alternatively, in some embodiments, if multiple objects are in the image data, the electronic device 101 would optionally present a navigation instruction relative to the first object it identifies; in this way, the electronic device 101 conserves computing resources as it optionally does not have to process a full image capture captured by the cameras 602, but can stop the processing of the image data once the electronic device 101 identifies an object (e.g., a first recognized object) in the image data.

FIGS. 6L and 6M illustrate an alternative embodiment of the destination of the navigation being inside of a building instead of outside of the building as in FIGS. 6I-6K, and the electronic device presenting navigation instructions as the location of the electronic device approaches the destination in accordance with some embodiments.

In FIG. 6L, the electronic device 101 presents navigation instruction 612g, which includes an identification of door 622 in the image data detected by the cameras 602. In the illustrated case, the recognized object is door 622, and the navigation instruction 612g indicates an instruction for the user 102 to go through the door 622 (e.g., to open the door 622 to go inside of the building 624). In FIG. 6M, the electronic device 101 has been moved further in the building 624, and the cameras 602 are still active optionally because the electronic device 101 is not yet at the destination location. In FIG. 6M, the view of the cameras 602 includes potted plant 626. In some embodiments, the electronic device 101 maintains a mapping of objects identified in the image data detected by the cameras 602. After the electronic device 101 presents navigation instruction 612g, and after the electronic device 101 is moved in accordance with navigation instruction 612g, the electronic device 101 optionally presents a navigation instruction 612h which indicates to the user 102 that the destination of the navigation has been reached, as shown in FIG. 6N.

FIGS. 6O and 6P illustrate an example of the electronic device entering a navigation mode again for navigating the electronic device to a different destination in accordance with some embodiments.

In FIG. 6O, device 101a detects input requesting initiation of navigation to different location after the navigation to the destination of FIG. 6M has been complete. For example, device 101a optionally detects contact of a portion of the user 102 (e.g., a finger) on a touch screen of device 101a at a location of a start user interface element being displayed on the touch screen. In response to the input, the navigation mode for navigating to the different location is initiated. In FIG. 6P, the electronic device 101 presents a navigation instruction 612i, which includes an identification of an object that is not in the field of view of the cameras 602 at the moment of presentation. In some embodiments, navigation instruction 612i is presented at device 101a (e.g., via display on device 101a and/or via another output mechanism on device 101a) and/or via an output mechanism (e.g., an audio output mechanism or another output mechanism) at electronic device 101. In some embodiments, navigation instruction 612i is presented because the electronic device 101 has stored a mapping of the objects and of the relative locations of the objects relative to a location of the electronic device (and/or relative to the direction that the cameras 602 are facing). In this way, the electronic device 101 can present navigation instruction relative to objects that were previously in the field of view of the cameras 602 and not in the field of view of the cameras 602 when the navigation instruction is presented.

FIG. 6Q illustrates an example schematic 628 of an electronic device toggling image recognition features based on a location of the electronic device and/or based on a mode of transport of the electronic device in accordance with some embodiments.

FIG. 6Q shows a route having three segments—first segment 630, second segment 632, and third segment 634. The first segment 630 and the third segment 634 involve the same mode of transport and the second segment involves a different mode of transport. For example, in the first segment 630 and the third segment 634, the mode of transport of the electronic device 101 is optionally walking of the user, and in the second segment 632, the mode of transport is optionally a subway train. In some embodiments, the electronic device 101 performs recognizing of objects while the electronic device 101 is in the first segment 630 and the third segment because the mode of transport is a mode of transport for which the navigation application permits recognizing of objects. In some embodiments, the electronic device 101 does not perform recognizing of object while the electronic device 101 is in the second segment because the mode of transport in the second segment is a mode for which the navigation application restricts performance of recognizing of objects. The electronic device 101 conserves computing resources by toggling performance of recognizing of objects in different modes of transport. Toggling of performance of recognizing of objects based on mode of transport and/or location is described further with reference to embodiment(s) of method(s) 700 and/or 800.

FIG. 7 illustrates a flow diagram illustrating a method 700 for presenting navigation instructions relative to recognized objects in response to detecting image data that includes the recognized objects in accordance with some embodiments of the disclosure. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

In some embodiments, method 700 is performed at an electronic device in communication with one or more input devices, including one or more image capture devices (e.g., cameras), and one or more output devices (e.g., presentation devices that present content and/or an experience to a user (e.g., a user of the electronic device), such as audio output devices, haptic devices, and display devices). For example, the electronic device is optionally a head mounted display or device (HMD) and/or a body-mounted display or device, a mobile device (e.g., a tablet, a smartphone, a media player, or a wearable device) including wireless communication circuitry, optionally in communication with one or more of headphones and/or earbuds that optionally includes one or more cameras and/or inertial measurement units (IMU), a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the electronic device includes display generation component that is a display integrated with the electronic device (optionally a touch screen display), external display such as a monitor, projector, television, or a hardware component (optionally integrated or external) for projecting a user interface or causing a user interface to be visible to one or more users, etc. The one or more output devices optionally include audio output devices such as headphones, earphones, and/or speakers, haptic devices, and/or display devices.

In some embodiments, while a navigation mode for navigating the electronic device from a first location to a second location is active, and while the electronic device is at a first determined location, the electronic device detects (702a) image data via the one or more image capture devices, wherein the one or more image capture devices are at the first determined location, such as cameras 602 in FIG. 6C capturing image data and the location of the electronic device 101. For example, a maps application on the electronic device is optionally active and is configured to provide navigation instructions to the user of the electronic device. The maps application optionally utilizes satellite tracking technology, GPS, and/or another location tracking mechanism to determine the first determined location of the electronic device. In some embodiments, the navigation mode is a mode of a location tracking application that is on the electronic device (or of a location tracking feature accessible on the electronic device via a maps application or via other application). In some embodiments, the image capture devices face a direction of the viewpoint and/or perspective of the user. For example, when the user is facing a first direction at the first determined location, the image capture devices detect first image data that is in that first direction from the location of the user, and when the user is facing a second direction, at the first determined location, different from the first direction, the image capture devices detect second image data different from the first image data that is in that second direction from the location of the user. In some embodiments, a direction or perspective of the captured images is controlled by the head orientation/direction of the user, and the image data corresponds to some or all of what is visible to the user (e.g., in a field of view of the user) when the user is facing that direction or perspective.

In some embodiments, in response to detecting the image data via the one or more image capture devices, in accordance with a determination that the image data includes a first recognized object and not a second recognized object, such as including the mailbox 608 in FIG. 6C and not the flowers 614 of FIG. 6F, the electronic device presents (702b), via the one or more output devices, a first navigation instruction, the first navigation instruction being relative to the first recognized object for navigating to the second location, such as navigation instruction 612a in FIG. 6C. In some embodiments, the presented first navigation instruction identifies the first recognized object, such by the electronic device verbally naming the first recognized object and/or one or more characteristics of the first recognized object. For example, the presented first navigation instruction optionally includes a naming of the first recognized object in addition to a naming of one or more characteristics (e.g., a size, a color, an orientation, or another characteristic) of the first recognized object. For example, when the first recognized object is a phonebooth that is red, the electronic device optionally verbally names “red phonebooth” within the first navigation instruction so as to assist the user of the electronic device in navigating to the second location (e.g., with directions relative to that red phonebooth) using that which is identified in the image data. In some embodiments, the presented first navigation instruction includes one or more audio tones, with or without a verbal instruction that identifies the first recognized object. In some embodiments, the electronic device determines a distance to the first recognized object, a distance to a maneuver that is relative to the first recognized object, and/or a distance between the first recognized object and the maneuver that is relative to the first recognized object. In some embodiments, the first navigation instruction includes a verbal notification of one or more of the distances described above. For example, the first navigation instruction optionally includes a verbal notification of “In 50 ft make a right at the red phonebooth.” In this verbal notification, the electronic device optionally identifies a distance between the user of the electronic device and the maneuver or a distance between the user of the electronic device and the red phone booth. In some embodiments, the first navigation instruction is the identification of the first recognized object (e.g., a verbal naming of the first recognized object and/or one or more characteristics of the first recognized object) and a navigation maneuver (e.g., behind, to the right, to the left, or another navigation maneuver) that is relative to the first recognized object. In some embodiments, the first navigation instruction is presented as a visual instruction, in addition or alternatively to an audio instruction. For example, the first navigation instruction is optionally displayed on a display, such as a mobile device (e.g., a phone or watch), or on a head-mounted display system, in addition or alternatively to being presented via audio. In some embodiments, the electronic device processes the image data to determine whether the image data includes a recognized object. In some embodiments, the electronic device processes the image data to determine whether the image data includes the first recognized object, and if it is determined that the image data includes the first recognized object before a determination is made as to whether the image data includes the second recognized object, then the electronic device presents the first navigation instruction relative to the first recognized object, without further processing of the image data (e.g., without further processing the image data to determine whether the image data includes the second recognized object), which optionally conserves computing resources. In some embodiments, the first navigation instruction is based on the current viewpoint and/or perspective of the user when the image data is detected.

In some embodiments, in response to detecting the image data via the one or more image capture devices, in accordance with a determination that the image data includes a second recognized object and not the first recognized object, such as including the flowers 614 in FIG. 6F and not the mailbox 608, the electronic device presents (702c), via the one or more output devices, a second navigation instruction, different from the first navigation instruction, the second navigation instruction being relative to the second recognized object for navigating to the second location, different from the first navigation instruction relative to the first recognized object for navigating to the second location, such as the navigation instruction 612b in FIG. 6F. In some embodiments, the presented second navigation instruction identifies the second recognized object, such by the electronic device verbally naming the second recognized object and/or one or more characteristics of the second recognized object. For example, the presented second navigation instruction optionally includes a naming of the second recognized object in addition to a naming of one or more characteristics of the second recognized object. For example, when the first recognized object is a stroller that is black, the electronic device optionally verbally names “black stroller” so as to assist the user of the electronic device in navigating to the second location (e.g., with directions relative to that black stroller) using that which is identified in the image data. In some embodiments, the presented second navigation instruction includes one or more audio tones, with or without verbal instruction that identifies the second recognized object. In some embodiments, the electronic device determines a distance to the second recognized object, a distance to a maneuver that is relative to the second recognized object, and/or a distance between the second recognized object and the maneuver that is relative to the second recognized object. In some embodiments, the second navigation instruction includes a verbal notification of one or more of the distances described above. For example, the second navigation instruction optionally includes a verbal notification of “go pass the black stroller that is 10 ft ahead of you.” In this verbal notification, the electronic device optionally identifies a distance between the user of the electronic device and the black stroller. In some embodiments, the second navigation instruction is the identification of the second recognized object (e.g., a verbal naming of the first recognized object and/or one or more characteristics of the second recognized object) and a navigation maneuver (e.g., behind, to the right, to the left, or another navigation maneuver) that is relative to the second recognized object, both of which could be different than the first navigation instruction. In some embodiments, the first navigation instruction is presented as a visual instruction, in addition or alternatively to an audio instruction. For example, the first navigation instruction is optionally displayed on a display, such as a mobile device (e.g., a phone or watch), or on a head-mounted display system, and/or via a virtual reality/augment reality (VR /R) display system, in addition or alternatively to being presented via audio. In some embodiments, the electronic device processes the image data to determine whether the image data includes a recognized object. In some embodiments, the electronic device processes the image data to determine whether the image data includes the second recognized object, and if it is determined that the image data includes the second recognized object before a determination is made as to whether the image data includes the first recognized object, then the electronic device presents the second navigation instruction relative to the second recognized object, without further processing of the image data (e.g., without further processing the image data to determine whether the image data includes the first recognized object), which optionally conserves computing resources. In some embodiments, the second navigation instruction is based on the current viewpoint and/or perspective of the user when the image data is detected. Detecting image data via image capture devices that are at a first determined location of the electronic device, presenting a first navigation instruction relative to a first recognized object in the image data in accordance with a determination that the image data includes the first recognized object without including a second recognized object, and presenting a second navigation instruction relative to the second recognized object in the image data in accordance with a determination that the image data includes the second recognized object without including the first recognized object enhances computer-assisted navigation of the user of the electronic device in navigating from a first location to a second location and reduces errors associated with navigating the user from the first location to the second location, since the navigation instructions are based on image data captured by the electronic device at the location of the electronic device and different navigation instructions are provided based on different recognized objects in the image data.

In some embodiments, the first recognized object is not an official traffic-orienting object, and the second recognized object is not an official traffic-orienting object. For example, the mailbox 608 in FIG. 6C is a mailbox and the flowers 614 in FIG. 6F are flowers, both of which optionally are not typically considered official traffic-orienting objects. For example, the first recognized object and/or the second recognized object is optionally not a posted (e.g., removable or non-removably posted) street sign (e.g., a stop sign, a pedestrian sign, a lane indicator) or a street light, or another type of official traffic-orienting object that is optionally recognized as an official traffic-orienting object by a governing jurisdiction (e.g., a city) at current location of the location of the electronic device. In some embodiments, the non-traffic orienting objects include objects that are not indicated or reported or reportable via a distributed object reporting system, such as a hazard reporting system (e.g., a police car spotting system or a pothole reporting system). In some embodiments, the non-traffic orienting object include objects that are not verbally or visually identified in a location tracking system, such as global positioning system. Additionally or alternatively, in some embodiments, the first recognized object and/or the second recognized object are traffic-orienting objects, such as street lights, street signs, and/or other traffic-orientating objects (e.g., official traffic-orienting object by a governing jurisdiction at the current the location of the electronic device). Presenting navigation instructions relative to objects that are not traffic-orienting objects allows navigating based on a current specific context of the user which makes navigating more efficient.

In some embodiments, the determination that the image data includes the first recognized object and not the second recognized object includes a determination that the first recognized object includes one or more characteristics of a set of objects (e.g., a set of one or more objects) in an image recognition system in communication with the electronic device while the electronic device is in the navigation mode. In some embodiments, the determination that the image data includes the second recognized object and not the first recognized object includes a determination that the second recognized object includes one or more characteristics of the set of objects (e.g., a set of one or more objects) in the image recognition system in communication with the electronic device while the electronic device is in the navigation mode. For example, the electronic device optionally presented navigation instruction 612a in FIG. 6C, which is relative to the mailbox 608, and navigation instruction 612f in FIG. 6F, which is relative to the flowers 614, after a determination was made that said objects are of the likeness of objects that the image recognition system is configured to recognize. The image recognition system is optionally a system that receives as an input at least image data and then outputs a result identifying whether there is a recognized object in the image data. The image recognition system is optionally trained based on one or more data sets of image data that include recognized objects and on one or more datasets of image data that do not include recognized objects. For example, if the first recognized object is a red phonebooth, the red phonebooth in the image data is optionally identified as a phonebooth based on training data that includes phonebooths of different sizes, colors, and/or shapes, and/or the based on an interference made by the image recognition system in view of other context clues (e.g., a person inside the red phonebooth having a phone next to the ear of the person). In some embodiments, the image recognition system includes one or more artificial intelligence (AI) systems that assist in the determination that the image data includes the first or second recognized objects. Before presenting the first or second navigation instruction, the electronic device optionally transmits the detected image data to the image recognition system, and then receives a result from the image recognition system regarding whether the image data includes the first recognized object and/or the second recognized object. In some embodiments, the image recognition system is fully downloaded on the electronic device, such that the image recognition system can be active even when the electronic device is not connected to the Internet. In some embodiments, the image recognition system is partially downloaded on the electronic device, such that a first set of operations involving the image recognition system is performed locally at the electronic device (e.g., optionally with or without an Internet connection or another wired or wireless connection), and a second set of operations involving the image recognition system is performed remote from the electronic device optionally with Internet connection or another wired or wireless connection. In some embodiments, the image recognition system is fully remote from the electronic device, such that all operations involving the image recognition system are performed remote from the electronic. Identifying the first and second recognized objects based on training data allows navigation to a location to be more efficient because the system is trained to determine whether recognized objects are in the current perspective of the user.

In some embodiments, the first navigation instruction relative to the first recognized object for navigating to the second location includes direction information relative to the first recognized object, such as shown with the navigation instruction 612a of FIG. 6F. For example, the direction information is optionally based on a location of the user relative to the first recognize object. For example, the direction information optionally includes a cardinal direction (e.g., north, south, east, west, southwest, or another direction) relative to the first object or another type of direction information that is relative to the first object. In some embodiments, the navigation instruction is different for different locations of the user relative to the first object. For example, if the location of the user is first location relative to the first object, then the electronic would optionally present a first navigation instruction including first direction information, and if the location of the user is a second location relative to the first object, different form the first location (e.g., offset by 2, 5, 20, 50, 60 degrees, or another offset from the first location, relative to the first object), the electronic device would optionally present a second navigation instruction, different from the first navigation instruction, including second direction information different from the first direction information. In some embodiments, the navigation instruction is different when a difference between the first and second locations relative to the object is more than a threshold amount of difference (e.g., offset by 10, 20, 50, 60 degrees, or another offset from the first location, relative to the first object). In some embodiments, the navigation instruction is the same when a difference between the first and second locations relative to the object is less than the threshold amount of difference. In some embodiments, the second navigation instruction relative to the second recognized object for navigating to the second location includes direction information relative to the second recognized object. Presenting direction information relative to a location of the first object identifies a direction for navigating from a current location of the electronic device, makes navigation systems more efficient since the direction is a function of the current location of the electronic device and the location of the first object, and reduces errors when using the electronic device to navigate to a destination.

In some embodiments, the direction information relative to the first recognized object is to the right of, to the left of, above, below, through, or another direction relative to the first recognized object, such as shown with the navigation instruction 612e of FIG. 6J. For example, the first object is a door, and the electronic device optionally presents an instruction to travel through the door. As another example, the first object is a set of steps, and the set of steps is below a ground-level of the user of the electronic device, and the electronic device optionally presents an instruction to go down the stairway. As another example, the first object is a set of steps, and the set of steps is above a ground-level of the user of the electronic device, and the electronic device optionally presents an instruction to go up the stairway. Similarly, in some embodiments, the direction information relative to the second recognized object is to the right of, to the left of, above, below, through, or another direction relative to the second recognized object. As such, the electronic device optionally provides directional instructions that are based on a location of the user relative to the recognized object and/or based on a location of the recognized object relative to the user. Further, as shown in the examples above, the directional instructions optionally identify the recognized object to which the navigation instruction is associated. Presenting direction information relative to a location of the first object identifies a direction for navigating from a current location of the electronic device, makes navigation systems more efficient since the presented direction is a function of the current location of the electronic device and the location of the first object, which is seen by the cameras of the electronic device, and reduces errors when using the electronic device to navigate to a destination.

In some embodiments, presenting, via the one or more output devices, the first navigation instruction relative to the first recognized object for navigating to the second location is also in accordance with a determination that a user of the electronic device is facing a first direction at the first determined location and a determination that a perspective of the user includes the first recognized object. For example, navigation instruction 612a in FIG. 6C is presented optionally because field of view of the user includes the mailbox 608 in FIG. 6C. In some embodiments, presenting, via the one or more output devices, the second navigation instruction relative to the second recognized object for navigating to the second location is also in accordance with a determination that the user of the electronic device is facing a second direction, different from the first direction, at the first determined location and a determination that a perspective of the user includes the second recognized object. For example, navigation instruction 612b in FIG. 6F is presented optionally because field of view of the user includes the flowers 614 in FIG. 6F. As such, the electronic device optionally provides different navigation instructions at the first determined location of the electronic device based on the direction that the user of the electronic device is facing at the first determined location. For example, the first determined location is in between a location of the first object and a location of the second object, and the electronic device optionally presents the first or second navigation instruction based on whether the perspective of the user at the first determined location includes the first object or includes the second object. For example, if the electronic device identifies an object that, in the current perspective of the user, is to the right of a location at which a next navigation maneuver is to be made, then the electronic device optionally presents a navigation instruction that includes instructions to make the navigation maneuver at the location, including an identification that that the location is to the left of the object in the perspective of the user. Continuing with this example, if the electronic device identifies an object that, in the current perspective of the user, is to the left of the location at which the next navigation maneuver is to be made (and optionally the object that is to the right of the location is not the current perspective of the user based on the direction the user faces), then the electronic device optionally presents a navigation instruction that includes instructions to make the navigation maneuver at the location, including an identification that that the location is to the right of the object in the perspective of the user. In this way, the navigation instructions that are provided by the electronic device are further contextualized to the direction that the user is facing, in addition to being contextualized to objects that are in the perspective of the user. Presenting different navigation information based on the direction that the user of the electronic device is facing makes navigation systems more efficient because the navigation instructions identify objects that are in the direction that the user is facing, and reduces errors when using the electronic device to navigate to a destination.

In some embodiments, the one or more output devices includes one or more audio output devices (e.g., speakers, headphones, or earphones) and presenting, via the one or more output devices, the first navigation instruction relative to the first recognized object for navigating to the second location includes presenting, via the one or more audio output devices, one or more first audio components as spatialized audio, such as navigation instruction 612a in FIG. 6C being presented to the user 102 via headphones 604. In some embodiments, the first audio components that are spatialized in presentation are tones and/or speech content (e.g., verbal content) that are placed at one or more locations in the three-dimensional environment of the user of the electronic device, optionally to simulate the first audio components being presented from one or more distances away from the location of the user of the electronic device. In some embodiments, presenting the second navigation instruction relative to the second recognized object for navigating to the second location includes presenting, via the one or more audio output devices, one or more second audio components as spatialized audio. Guiding the user of the electronic device using spatialized audio assists the user with navigating to a destination, makes navigation systems more efficient, and reduces errors when using the electronic device to navigate to a destination.

In some embodiments, the first recognized object is at a first respective location, and the one or more first audio components are presented as emanating from the first respective location, such as described with navigation instruction 612a in FIG. 6E being presented at the location of the mailbox 608. For example, the first audio components are presented as emanating from the location of the recognized object. In this way, the user of the electronic device is not just presented with contextualized navigation instructions that are relative to recognized objects that are in the perspective of the user. Rather, the contextualized navigation instructions that are relative to recognized objects that are in the perspective of the user are further presented as spatialized audio emanating from the location associated with the recognized objects. In some embodiments, presenting the first audio components as emanating from the first respective location includes in accordance with a determination that the user of the electronic device is facing a first direction, presenting the first audio components as emanating from a second direction relative to the first direction, and in accordance with a determination that the user of the electronic device is facing a third direction, different from the first direction, presenting the first audio components as emanating from a fourth direction relative to the third direction, different from the second direction relative to the first direction. As such, if the user is facing different directions when the first audio components are presented, the audio is optionally presented to the user as if emanating from different relative directions. In some embodiments, in accordance with a determination that a distance between the user of the electronic device and the object is a first distance, the electronic device presents the first audio components having a first volume level (e.g., a first sound intensity), and in accordance with a determination that the distance between the user of the electronic device and the object is a second distance, different from the first distance, the electronic device presents the first audio components having a second volume level (e.g., a second sound intensity) different from the first volume level. As such, the audio is optionally presented to the user with different volume levels based on the distance between the user and the object. In some embodiments, in accordance with a determination that the first respective location is a first location, the electronic device presents the first audio components as emanating from the first location, and in accordance with a determination that the first respective location is a second location, different from the first location, the electronic device presents the first audio components as emanating from a second location, different from the first location. As such, the electronic device optionally presents the first audio components based on a location of the object. In some embodiments, the second recognized object is at a second respective location, and the one or more second audio components are presented as emanating from the second respective location. Presenting navigation instructions as audio emanating from a location of the recognized object enhances navigation systems because it enables the user to identify or confirm where the recognized object is by determining where the spatialized audio is being presented from, which reduces errors when using the electronic device to navigate to a destination.

In some embodiments, the first recognized object is at a first respective location, the first navigation instruction relative to the first recognized object for navigating to the second location includes an instruction corresponding to a first navigation maneuver to be completed at a first respective spatial relationship relative to the first recognized object (e.g., at a location that is to the right of, left of, above, or below, or another first respective spatial relationship), and the one or more first audio components are presented as emanating from a location that is offset from the first respective location and has the first respective spatial relationship relative to the first respective location, such as described with reference to navigation instruction 612a in FIG. 6C being presented leftward of the location of the mailbox 608. For example, the recognized object is a tree, the instruction is to go to the right of the tree, which is up ahead in 30 feet, and the instruction is presented at a location that is to the right of the tree (and optionally 30 feet ahead of the user, which is optionally the desired location that the navigation system intends for the user to be located. For example, if the user is to be directed to the right of the first object based on the perspective of the user (e.g., relative to the location of the user of the electronic device), then the electronic device optionally places the first audio components such that they are emanating from the right of the first object in the perspective of the user, and if the user is to be directed to the left of the first object based on the perspective of the user (e.g., relative to the location of the user of the electronic device), then the electronic device optionally places the first audio components such that they are emanating from the left of the first object in the perspective of the user. In some embodiments, presenting the first audio components as emanating from the location that is offset from the first respective location and has the first respective spatial relationship relative to the first respective location includes in accordance with a determination that the user of the electronic device is facing a first direction, presenting the first audio components as emanating from a second direction relative to the first direction, and in accordance with a determination that the user of the electronic device is facing a third direction, different from the first direction, presenting the first audio components as emanating from a fourth direction relative to the third direction, different from the second direction relative to the first direction. As such, if the user is facing different directions when the first audio components are presented, the audio is optionally presented to the user as if emanating from different relative directions. In some embodiments, the second recognized object is at a second respective location, and the second navigation instruction relative to the second recognized object for navigating to the second location includes an instruction corresponding to a second navigation maneuver to be completed at a second respective spatial relationship relative to the second recognized object (e.g., to the right of, left of, above, or below, or another second respective spatial relationship), and the one or more second audio components are presented as emanating from a location that is offset from the second respective location and has the second respective spatial relationship relative to the second respective location. Presenting navigation instructions as audio emanating from a location of a maneuver relative to the recognized object enhances navigation systems because it enables the user to identify or confirm where the maneuver is to be performed relative to the recognized object by determining where the spatialized audio is being presented from, which reduces errors when using the electronic device to navigate to a destination.

In some embodiments, while the navigation mode for navigating the electronic device from the first location to the second location is active, the electronic device presents, via the one or more output devices, a third navigation instruction that confirms that the user of the electronic device is navigating to the second location, such as navigation instruction 612c in 6H. In some embodiments the third navigation instruction is presented after a threshold amount of time (e.g., 30 seconds, one minute, two minutes, three minutes, five minutes, or another threshold period of time) is passed since the electronic device has presented a navigation instruction (e.g., the first or second navigation instruction described above). In some embodiments the third navigation instruction is an instruction to continue along a given path that the electronic device previously instructed the user to navigate onto. In some embodiments, the third navigation instruction does not include identification of a recognized object. In some embodiments, the third navigation instruction includes identification of a recognized object. In some embodiments, the confirmation navigation instruction (e.g., the third navigation instruction) is presented in accordance with a determination that the electronic device is on the determined path for the threshold amount of time and/or for a threshold distance (e.g., 10, 15, 30, 100, 200 m, or another threshold distance). In some embodiments, the confirmation navigation instruction is presented each time the threshold amount of time is past and/or each time the threshold distance is traversed while the navigation mode is active. In some embodiments, the third navigation instruction is presented while the cameras are not detecting image data. In some embodiments, the third navigation instruction is presented while the camera are detecting image data. Presenting a confirmation that the user of the electron device is keeping route to the second location provides a confirmation that the user is navigating to the destination as instructed by the navigation system and reduces errors with interacting with the electronic device to navigate to a destination.

In some embodiments, while a third recognized object is in a field of view of the one or more image capture devices, the electronic device detects, via the one or more image capture devices, image data that includes the third recognized object, such as potted plant 626 in FIG. 6M. In some embodiments, after detecting the image data that includes the third recognized object and while the third recognized object is not in the field of view of the one or more image capture devices, the electronic device presents, via the one or more output devices, a third navigation instruction relative to the third recognized object, such as navigation instruction 612i in FIG. 6P. As such, in some embodiments, the electronic device presents navigation directions that are relative to an object that was previously in the field of view of the cameras and is no longer in the field of view. In some embodiments, the third navigation instruction is presented after a period of time (e.g., 30 s, 1 min, 5 min, 20 min, 1 hr, or another period of time) of the third object being in the field of view of the cameras. In some embodiments, when the third navigation instruction is presented, one or more objects different from the third object are in the field of view of the cameras or no recognized objects are in the field of view of the cameras. In some embodiments, the third navigation instruction is presented because a (next) segment of the route is not in the current field of view of the cameras when the third navigation instruction is presented. In some embodiments, the third navigation instruction is presented because a (next) segment of the route is not in the current field of view of the cameras when the third navigation instruction is presented, even if one or more other objects are in the current field of view of the cameras when the third navigation instruction is presented. In some embodiments, the trigger for presenting the third navigation instruction is different from (e.g., is not) the third object being in the field of view of the cameras when the third navigation instruction is triggered and/or initiated to be presented. In some embodiments, the object was not in the field of view of the cameras when the first or second navigation instruction was presented. For example, the object was in the field of view of the cameras before or after the first or second navigation instruction was presented. In some embodiments, the electronic device detects the object and presents the navigation instruction relative to the object while the navigation mode for navigating the electronic device from the first location to the second location is active. In some embodiments, the electronic device detects the object while navigating from the first to the second location, but presents the navigation instruction relative to the object while navigating to a different destination than the second location. For example, the electronic device optionally detects the object while navigating to the second location, and then, optionally after reaching the second location or after exiting the navigation mode, the electronic device enters the navigation mode again but for routing to a third location. Continuing with this example, the electronic device optionally presents the navigation instruction relative to the object that was detected while the navigation mode for navigating the electronic device from the first location to the second location was active. Thus, in some embodiments, the electronic device stores data (e.g., image data) corresponding to the object that was in the field of view of the cameras and optionally presents a navigation instruction relative to that object (e.g., the third recognized object) while that object is no longer in the field of view of the cameras. For example, the electronic device optionally generates and maintains a mapping of objects that were in a field of view of the cameras, and can later using such mapping for navigating even if the objects are not in the field of view of the cameras when the electronic device presents a navigation instruction relative to one of those objects. Such features make navigating to the second location more efficient, such as when the object would likely be remembered by the user of the user of the electronic device. For example, the navigation instruction optionally include navigating into a room through a door, and the electronic device optionally maintains data corresponding to characteristics of the door (e.g., where the door is located and that the electronic device entered the door in order to get into the room) and can use such information later, such as by presenting a navigation instruction relative to the door while the door is not in the field of view of the cameras when it is presented. Presenting navigation instructions relative to previously recognized objects that are no longer in a field of view of the cameras makes navigating more efficient because the system can navigate using previously recognized objects in addition to recognized objects that are in the field of view of the cameras, which altogether enhances navigating, and reduces errors when using the electronic device to navigate to a destination.

In some embodiments, presenting, via the one or more output devices, the first navigation instruction includes in accordance with a determination that a third recognized object was in a field of view of the one or more image capture devices before the electronic device is at the first determined location, and that a fourth recognized object was not in the field of view of the one or more image capture devices before the electronic device is at the first determined location, presenting, via the one or more output devices, a third navigation instruction for navigating to the second location. For example, were the mailbox 608 in the field of view of the cameras 602 without the flowers 614 being in the field of view before the electronic device 101 is at its location in FIG. 6C, the electronic device 101 optionally presents navigation instruction 612a of FIG. 6C. The third navigation instruction is optionally relative to the first object or to the third object. Thus, in some embodiments, the first navigation instruction is different depending on which object was in the field of view of the cameras before the electronic device is at the first determined location.

In some embodiments, in accordance with a determination that the fourth recognized object was in the field of view of the one or more image capture devices before the electronic device is at the first determined location, and that the third recognized object was not in the field of view of the one or more image capture devices before the electronic device is at the first determined location, presenting, via the one or more output devices, a fourth navigation instruction for navigating to the second location. For example, were the flowers 614 in the field of view of the cameras 602 without the mailbox 608 being in the field of view of the cameras 602 before the electronic device 101 is at its location in FIG. 6F, which is the same location as in FIG. 6C, the electronic device 101 optionally presents navigation instruction 612b of FIG. 6F. The fourth navigation instruction is optionally relative to the first object or to the fourth object. Thus, in some embodiments, the first navigation instruction is different depending on which object was in the field of view of the cameras before the electronic device is at the first determined location. In some embodiments, the electronic device provides different directions depending on what was captured in the field of view of the cameras up to the point of navigation to the current location of the electronic device. Thus, in some embodiments, even if the electronic device were moved along the same route while navigating from the first location to the second location, the navigation instructions that are presented during said navigation would optionally be different if different objects were in the field of view of the cameras during the navigation and/or if the cameras were facing different directions along the same route. For example, if while traveling up to the current location of the electronic device the cameras captured images including a parked bicycle, then the electronic device would optionally have presented a navigation instruction relative to the bicycle, and if the cameras captured images that do not include the bicycle but included a skateboard, the electronic device would optionally present navigation instructions relative to the skateboard, without ever presenting a navigation instruction relative to the bicycle since the cameras in this case never captured images that included the bicycle. As such, in some embodiments, the electronic device provides different directions depending upon differences in content captured by the cameras (e.g., such as do to the camera being posed differently (e.g., facing different directions) at different times while navigating to the electronic device's current location. Presenting different navigation instructions at a first current location of the electronic device based on which objects are in the field of view of the cameras before the electronic device is at the first current location contextualizes the navigation instructions to what is in the field of view of the cameras and reduces errors when using the electronic device to navigate to a destination.

In some embodiments, the first navigation instruction (and/or optionally the second navigation instruction) includes instructions for proceeding to a next segment of a route that is to the second location, and the first determined location is part of a current segment of the route, prior to the next segment of the route, such as shown with navigation instruction 612a in FIG. 6C including instructions for proceeding from segment 605 to segment 607. In some embodiments, the next segment of the route to the second location is a street, walkway, or another type of path or terrain, that is optionally somewhere along the route in between the first and the second location. In some embodiments, the instructions for proceeding to the next segment include instructions to turn left or right at the recognized object, go into recognized object, go beside (e.g., walk beside) the recognized object, and/or another instruction relative to the recognized object. In some embodiments, the current segment and the next segment of the route is separated by a maneuver (e.g., a turn or another maneuver). For example, to get to the next segment in accordance with the instructions from the current segment the electronic device (and/or the user) optionally has to make and/or complete the maneuver (e.g., turning right, turning left, turning around, continuing straight, taking the right fork, taking the left fork, etc.) between the segments. Presenting navigation instructions, relative to recognized objects, suggestive of how to proceed to a next segment of a route timely notifies the user that a next segment of the route is upcoming, which reduces errors when using the electronic device to navigate to a destination.

In some embodiments, the first navigation instruction (and/or the second navigation instruction) includes an indication of a location of a waypoint of a route that is to the second location, such as shown with navigation instruction 612f in FIG. 6K. For example, the waypoint is optionally a starting point, intermediate point (e.g., a point in between the starting point and the ending point), and/or an ending point of the route. For example, a car is parked to the right of a location of a waypoint, the car is in the field of view of the cameras, and the first navigation instruction optionally indicates (e.g., verbally indicates) that a waypoint on the way to the user's destination is next to the car on the right. For example, a car is parked next to the second location, and the first navigation instruction optionally identifies a location of the destination being relative to a recognized object of a car that is in the field of view of the cameras (e.g., the first navigation instruction optionally indicates (e.g., verbally indicates) the user's destination as being next to (e.g., to the right of) the parked car. As such, in some embodiments, the electronic device presents indications of locations of waypoints in the presentation of navigation instructions. Presenting navigation instructions, relative to recognized objects, suggestive of locations of waypoints timely notifies the user of the waypoints, which can indicate an amount of progress that has been made on the route to the second location and/or that is still to be made on the route to the second location and reduces errors when using the electronic device to navigate to a destination.

In some embodiments, the one or more image capture devices are being worn by a user of the electronic device, such as cameras 602 being worn by user 102 in FIG. 6A. For example, the cameras are optionally worn on a portion of the user's body, such as on a head, ears, wrists, arms, or another portion of the user. In some embodiments, at a location of the user in an environment, the cameras face the direction that the head of the user faces so that the camera can capture image data that overlap with the field of view of the user. Configuring the cameras to be worn of the user of the electronic device allows for real-time image detection that is based on the current location of the user of the electronic device and reduces errors when using the electronic device to navigate to a destination.

In some embodiments, the one or more image capture devices and the one or more output devices are included in a same device, such as cameras 602 and headphones 604 in FIG. 6A being included in the same device. For example, the cameras are optionally included in headphones and/or earphones devices, and the headphones and/or earphones devices are optionally configured to present audio of the navigation instructions. As another example, the cameras are included in an AR/VR pair of glasses, and the AR/VR glasses are optionally configured to present audio and/or visual navigation instructions. For example, the cameras and the presentation devices are optionally worn on a portion of the user's body, such as on a head, ears, wrists, arms, or another portion of the user, and are optionally part of the same device, such as a head-mounted device, an extended reality device (e.g., an augmented reality/virtual reality device, or another type of extended reality device). In some embodiments, the cameras and the presentation devices are worn on the same portion of the user. In some embodiments, the cameras are worn on a first portion of the user and the presentation devices are worn on a second portion of the user that is different from the first portion of the user. Including the cameras and presentation devices in the same device that is to be worn of the user allows for real-time image detection and navigation instruction presentation that is based on the current location of the user of the electronic device and reduces errors when using the electronic device to navigate to a destination.

In some embodiments, while the navigation mode for navigating the electronic device from the first location to the second location is active, and while the electronic device is at the first determined location, in accordance with a determination that one or more criteria are satisfied, including a criterion that is satisfied when recognition of objects in the image data detected by the one or more image capture devices is not performed (e.g., is not being performed or is being performed but no recognized object is detected), the electronic device presents, via the one or more output devices, a respective navigation instruction that is not based on the image data detected by the one or more image capture devices, such as navigation instruction 612d in FIG. 6I. In some embodiments, the criteria is satisfied after a threshold amount of time (e.g., 10 s, 15, 45 s, 1 min, 2 min, or another threshold amount of time) has passed while the cameras are detecting image data but no recognized object is in the image data. The respective navigation instruction is optionally based on location data (e.g., data about the location of the electronic device and/or about the orientation of the electronic device, such as GPS data, image-based location data, or other location data) without being based on image data. For example, the electronic device optionally provides navigation instructions that are independent of the image data detected by the cameras when no object is being recognized in the image data detected by the cameras (e.g., when neither the first or second recognized object is detected). Continuing with this example, the navigation instructions are optionally based on GPS, without being based on the image data from the cameras (e.g., without including or identifying an object that would not typically be provided in a GPS-only navigation). Still presenting a navigation instruction when recognizing of objects in the image data is not being performed allows the navigation mode to still navigate the user even when recognizing of objects in the image data is not being performed, confirms to the user that the navigation mode is active and working, and reduces errors when using the electronic device to navigate to a destination.

In some embodiments, while the navigation mode for navigating the electronic device from the first location to the second location is active, in accordance with a determination that the electronic device is at a first respective location while the navigation mode for navigating the electronic device from the first location to the second location is active, the electronic device forgoes performance of recognizing objects in detected image data via the one or more image capture devices, such as shown with the electronic device 101 not performing recognizing of objects in detected image data while the electronic device 101 is in second segment 632 in FIG. 6Q. In some embodiments, while the navigation mode for navigating the electronic device from the first location to the second location is active, in accordance with a determination that the electronic device is at a second respective location, different from the first respective location, while the navigation mode for navigating the electronic device from the first location to the second location is active, the electronic device performs recognizing objects in detected image data via the one or more image capture devices, such as shown with the electronic device 101 performing recognizing of objects in detected image data while the electronic device 101 is in first segment 630 in FIG. 6Q. As such, the electronic device optionally toggles performance of recognizing objects in detected image data detected via the cameras based on a location of the electronic device while the navigation mode is active. In some embodiments, when the performance of recognizing objects is inactive, the cameras are active or inactive. In some embodiments, when the performance of recognizing objects is active, the cameras are active. Toggling image processing based on location data conserves computing resource usage at the electronic device and makes navigating more efficient.

In some embodiments, while the navigation mode for navigating the electronic device from the first location to the second location is active:, in accordance with a determination that the electronic device is in a first mode of transport (e.g., via a boat, a car, a train, a subway train, a bus, or another mode of transport) to the second location while the navigation mode for navigating the electronic device from the first location to the second location is active, the electronic device forgoes performance of recognizing objects in detected image data via the one or more image capture devices, such as shown with the electronic device 101 not performing recognizing of objects in detected image data while the electronic device 101 is in second segment 632 in FIG. 6Q, which involves a first mode of transport. In some embodiments, in accordance with a determination that the electronic device is in a second mode of transport (e.g., via a bike, a walk of a user of the electronic device, or another mode of transport), different from the first mode of transport, to the second location, while the navigation mode for navigating the electronic device from the first location to the second location is active, the electronic device performs recognizing objects in detected image data via the one or more image capture devices, such as shown with the electronic device 101 performing recognizing of objects in detected image data while the electronic device 101 is in first segment 630 in FIG. 6Q, which involves a second mode of transport different from the mode of transport associated with second segment 632. As such, the electronic device optionally toggles performance of recognizing objects in detected image data detected via the cameras based on a mode of transport of the electronic device while the navigation mode is active. In some embodiments, when the performance of recognizing objects is inactive, the cameras are active or inactive. In some embodiments, when the performance of recognizing objects is active, the cameras are active. In some embodiments, navigating to from the first to the second location includes navigating using different modes of transport, and the electronic device toggles performance of recognizing objects in detected image data based on the current location of the electronic device relative to the mode of transport. For example, for a first portion of the route to the second location, the electronic device is being transported by walking of the user (e.g., the user of the electronic device walking in a walkway), and the recognizing of objects in detected image data is performed while the electronic device is located in the first portion of the route to the second location, and in a second portion of the route to the second location, different from the first portion, the electronic device is being transported by a subway train (e.g., the user of the electronic device is on a subway train), and the recognizing of objects in detected image data is not performed while the electronic device is located in the second portion of the route to the second location. In some embodiments, the electronic device performs different modes of image recognition based on the mode of transport of the electronic device. For example, the electronic device is optionally configured to perform image recognition in a first mode of transport that involves walking of the user of the electronic device and in a second mode of transport of that involves biking of the user. Continuing with this example, even if the cameras detect the same image data in each mode of transport, the navigation instructions that are presented relative to objects are optionally relative to different objects. That is, one or more or all objects that were used in navigation instructions in the first mode of transport (e.g., the walking of the user) would optionally be different from one or more or all objects that were used in navigation instructions in the second mode of transport (e.g., the biking of the user). In some embodiments, a mode of transport of the electronic device is determined based on the mode of transport permitted on and/or defined by the current segment of the route (e.g., defined by the navigation directions and/or the determined navigation route). Additionally or alternatively, in some embodiments, the mode of transport is determined based on performance of recognizing objects in detected image data captured from the cameras. Additionally or alternatively, in some embodiments, the mode of transport is determined based on motion (e.g., a speed of movement) detected by the electronic device (e.g., by sensors of the electronic device). Toggling image processing based on a mode of transport conserves computing resource usage at the electronic device and makes navigating more efficient.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 800) are also applicable in an analogous manner to method 700 described above with respect to FIG. 7. For example, the operation of presenting the first navigation instruction described above with reference to method 700 optionally has one or more of the characteristics of presenting the navigation instruction described herein with reference to other methods described herein (e.g., method 800). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, presenting operation 702b and 702c and detecting operation 702a are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIG. 8 illustrates a flow diagram illustrating a method 800 for presenting navigation instructions at different times based on when certain criteria are satisfied in accordance with some embodiments of the disclosure. The method 800 is optionally performed at first electronic device and/or electronic devices such as device 100, device 300, or device 500 as described above with reference to FIGS. 1A-1B, 2-3, 4A-4B and 5A-5H. Some operations in method 800 are, optionally combined and/or order of some operations is, optionally, changed.

In some embodiments, method 800 is performed at an electronic device in communication with one or more input devices, including one or more image capture devices, and one or more output devices: The electronic device optionally includes one or more characteristics of the electronic device described with reference to method 700; the one or more input devices, including the one or more image capture devices, optionally include one or more characteristics of the one or more input devices, including the one or more image captured devices, described with reference to method 700; the one or more output devices optionally include one or more characteristics of the one or more output devices described with reference to method 700. In some embodiments, while (802a) a navigation mode for navigating the electronic device from a first location to a second location is active (e.g., the navigation mode described with reference to method 700), at a first time (e.g., at a first time of day such as an occurrence of a time of day on a specific day, at a first time along a route to the second location, at a first distance along the route to the second location, when a first amount of progress along the route to the second location (e.g., 30% in distance and/or time progressed along the route to the second location) is complete, while the electronic device is in the navigation mode for navigating to the second location), in accordance with a determination that one or more criteria are satisfied at the first time, wherein the one or more criteria are satisfied based on image data from the one or more image capture devices, the electronic device presents (802b), via the one or more output devices, a navigation instruction, the navigation instruction being relative to a recognized object detected via the one or more image capture devices at the first time for navigating to the second location, such as navigation instruction 612a in FIG. 6C or navigation instruction 612b in FIG. 6C, and/or such as the first or second navigation instruction described with reference to method 700. In some embodiments, the one or more criteria are satisfied in accordance with a determination that the image data includes any recognized object, such as in accordance with the determination that the image data includes a first recognized object and not a second recognized object or the determination that the image data includes the second recognized object and not a first recognized object, as described with reference to method 700. Additionally or alternatively, in some embodiments, the one or more criteria are satisfied in accordance with a determination that the image data includes particular recognized objects, such as recognized objects of a particular type, such as traffic signals, signs, cars, trees, doors, billboards, or another type of object. Additionally or alternatively, in some embodiments, the one or more criteria are satisfied based on that which is captured by the one or more image capture devices up to the first time. The one or more image capture devices are optionally detecting images that are approximately overlapping or overlapping in the viewpoint and/or perspective of the user of the electronic device. For example, the one or more image capture devices are optionally being worn by the user of the electronic device (e.g., worn on the ears, head, body, and/or another portion of the user of the electronic device), and are capturing image data in front of the user of the electronic device. For example, if the head of the user of the electronic device is facing west, the one or more image capture devices are optionally facing west in accordance with the direction that the user of the electronic device is facing. As another example, if the head of the user is facing west and upward, the one or more image capture devices being worn on the user of the electronic device are optionally facing west and upward in accordance with the direction that the user of the electronic device is facing. When it is determined that the one or more criteria are satisfied at the first time, such as a criterion that includes identification of an object that the electronic device recognizes in the image data captured by the one or more image capture devices being satisfied at the first time, the electronic device optionally presents the navigation instruction relative to the recognized object at the first time. As such, the electronic device optionally presents navigation instructions based on that which is in the perspective and/or viewpoint of the user of the electronic device, as detected in real-time by the one or more image capture devices, thus providing more accurate directions based on what is in front of the user of the electronic device, which is a technical advantage over navigation systems and methods that do not account for objects that is in front of the user of electronic device as detected in real-time by the one or more image capture devices while the electronic device is being navigated to the second location. For example, if the user of the electronic device is walking in route to the second location, and in the path of the user of the electronic device is a flower bed, and the flower bed is a recognized object and the user is looking at the flower bed at the first time (e.g., the user is facing a direction that includes the flower bed in the viewpoint and/or perspective of the user of the electronic device), then the electronic device would optionally present the navigation instruction relative to the flower bed at the first time. In some embodiments, the electronic device presents the navigation instruction at a second time after the first time, provided that the electronic device recognizes the object in the image data at the first time during the navigation of the electronic device from the first to the second location. The characteristics of the navigation instruction relative to the recognized object of method 800 are optionally the same as described with reference to the first navigation instruction or the second navigation instruction of method 700 or include one or more characteristics thereof. For example, presenting the navigation instruction of method 800 optionally includes presenting audio including a verbal identification of the recognized object, optionally in addition to other features described with reference to method 700. In some embodiments, in accordance with a determination that the one or more criteria are not satisfied at the first time, the electronic device forgoes presenting (802c), via the one or more output devices, a respective navigation instruction (e.g., the navigation instruction described with reference to step 802b of method 800 or another navigation instruction that relative to a particular type of object in the image data (optionally independent of whether the object of the particular type is a recognized object or not)), such as shown with the electronic device 101 not presenting a navigation instruction in FIG. 6D. As such, in some embodiments, the navigation instruction is not presented at the first time if it is determined that the one or more criteria are not satisfied at the first time. For example, if there is no recognized object detected by the image capture devices at the first time, then the one or more criteria are optionally not satisfied at the first time, and the electronic device forgoes presenting, at the first time, the navigation instruction (e.g., any navigation instruction that uses the image data detected by the image capture devices at the first time). As another example, if the recognized object of step 802d of method 800 is not detected and/or not in the image data from the one or more image capture devices at the first time, then the one or more criteria are optionally not satisfied at the first time, and the electronic device forgoes presenting, at the first time, the navigation instruction that is relative to the recognized object of step 802d of method 800. For example, if the user of the electronic device is walking in route to the second location, and in the path of the user of the electronic device is a flower bed, but the user is not looking at the flower bed at the first time (e.g., the user is facing a direction that does not include the flower bed in the viewpoint and/or perspective of the user of the electronic device (e.g., the flower bed is not in the field of view of the user of the electronic device and/or of the one or more image capture devices at the first time)), then the electronic device would optionally forgo presenting the navigation instruction that is relative to the flower bed at the first time, since the flower bed is not in the view of the user of the electronic device at the first time. In some embodiments, at a second time, after the first time (e.g., at a second time of day such as an occurrence of a time of day on a specific day, at a second time along a route to the second location, at a second distance along the route to the second location, when a second amount of progress along the route to the second location (e.g., 50% in distance and/or time progressed along the route to the second location) is complete, while the electronic device is in the navigation mode for navigating to the second location, after the first time of day while the electronic device is in the navigation mode for navigating to the second location), in accordance with a determination that the one or more criteria are satisfied at the second time, the electronic device presents (802d), via the one or more output devices, the navigation instruction (or a different navigation instruction) relative to the recognized object (or a different recognized object) detected via the one or more image capture devices at the second time for navigating to the second location, such as shown with presentation of navigation instruction 612a in FIG. 6E. As such, the navigation instruction is optionally presented at the second time if it is determined that the one or more criteria are satisfied at the second time. For example, if the user of the electronic device is walking in route to the second location, and in the path of the user of the electronic device is a flower bed, but the user of the electronic device, at the first time, is not looking at the flower bed (e.g., is facing a direction that does not include the flower bed in the viewpoint and/or perspective of the user of the electronic device), but then, at a second time after the first time, the user is facing a direction that includes the flower bed in the viewpoint and/or perspective of the user of the electronic device, then the electronic device would optionally present the navigation instruction relative to the flower bed at the second time, without presenting the navigation instruction relative to the flower bed at the first time. As another example, when the navigation instruction is relative to the same recognized object, the navigation maneuver (of the navigation instruction) relative to that same recognized object is optionally different when presenting the navigation instruction at the second time compared with the navigation maneuver (of the navigation instruction) that would be presented if the navigation instruction was to be presented at the first time. The differences in navigation maneuvers associated with the navigation instruction presentation at the first and second times are optionally due to the electronic device detecting that the locations of the same recognized object relative to the user of the electronic device and/or relative to the viewpoint or perspective of the user of the electronic device at the first and second times are different. Thus, the electronic device can provide a user of the electronic device with contextual navigation instructions at different times (and optionally at different locations/distances along the route) relative to the same recognized object based on when the recognized object is in the viewpoint and/or perspective of the user of the electronic device and based on visual contextual data detected in real-time by cameras on the user as the user travels along a route to a destination. In some embodiments, the electronic device presents different navigation instructions at different times based on different recognized objects being in the viewpoint and/or perspective of the user of the electronic device at the different times. In some embodiments, provided that at the second time, the recognized object of step 802d of method 800 is not in the viewpoint and/or perspective of the user of the electronic device, but a second recognized object is in the viewpoint and/or perspective of the user of the electronic device, then the electronic device optionally presents a navigation instruction relative to the second recognized object, without presenting the navigation instruction that is relative to the recognized object of step 802d of method 800. Presenting a navigation instruction at a first time, or presenting it at a second time without presenting the navigation instruction at the first time, based on image data detected by cameras of the electronic device provides a contextual navigation instruction that is based on that which is detected by the cameras in real-time, which orients the user better for determining how to get to the destination of the navigation, and reduces errors resulting from navigation instructions provided by systems that do not account for what is currently in the viewpoint and/or perspective of the user of the electronic device during the navigation.

In some embodiments, the one or more criteria includes a criterion that is satisfied based on a location of the electronic device, such as the location of electronic device in FIG. 6C. For example, the criterion is satisfied when the location of the electronic device is a first location, and at the first time, if the location of the electronic device is not the first location, then the electronic device optionally does not present a navigation instruction. Continuing with this example, at the second time, if the location of the electronic device is the first location, then the electronic device optionally presents the navigation instruction. As such, the electronic device optionally presents a navigation instruction based on the location of the electronic device, in addition to based on image data from the cameras. In some embodiments, the image data is used in a determination of the location of the electronic device. In some embodiments, the image data is not used in a determination of the location of the electronic device (e.g., GPS data is used instead). Presenting a navigation instruction on based image data when the electronic device is at a location that, based on GPS data, would be associated with presentation of a GPS-based navigation instruction, enhances navigation to the second location since the presented navigation instruction is contextualized to what is currently in the field of view of the cameras, which reduces errors when using the electronic device to navigate to a destination.

In some embodiments, the electronic device is in communication with a global positioning system (GPS) while the navigation mode for navigating the electronic device from the first location to the second location is active, and the one or more criteria includes a criterion that is satisfied based on GPS data corresponding to a change in navigation directions relative to a current location (and/or current navigation segment or status) of the electronic device, such as GPS data indicating that a maneuver is upcoming when the electronic device 101 is at its illustrated location in FIG. 6C. In some embodiments, the GPS is used to determine the current location of the electronic device. In some embodiments, the GPS determines that the current location of the electronic device is within a threshold distance (e.g., 0.5 m, 1 m, 2 m, 5 m, 10 m, or 20 m, 25 m, or another threshold distance) from a next segment of a route to the second location and/or from a maneuver, such as described with reference to method 700, leading into the next segment of the route. In some embodiments, when the GPS data indicates that the current location is not within the threshold distance, the electronic device forgoes presenting the navigation instruction, and when the GPS data indicates that the current location is within the threshold distance, the electronic device presents the navigation instruction. In some embodiments, the electronic device presents a navigation instruction based on the location of the electronic device relative to a current segment of the route to the second location. For example, if the current location is within a threshold distance (e.g., 0.5 m, 1 m, 2 m, 5 m, 10 m, or 20 m, 25 m, or another threshold distance) of an end of a current segment of the route (e.g., is within a threshold of a change in navigation directions based on GPS data), the electronic device optionally presents the navigation instruction that is relative to the recognized object based on the current location being within that threshold distance. Presenting an image-based navigation instruction based on proximity to a next segment of a route as determined by GPS data indicates that a next segment of the route is upcoming and reduces errors when using the electronic device to navigate to a destination.

In some embodiments, before the electronic device is at the first location, in accordance with a determination that the electronic device is within a threshold distance (e.g., 50 m, 25 m, 10 m, 5 m, 1 m, or another distance) of the first location, but not at the first location, the electronic device activates the one or more image capture devices for performance of recognition of objects, such as cameras 602 being activated while the electronic device 101 is moved from its location in FIG. 6A, which is optionally outside of the threshold distance to its location in FIG. 6B, to its location in FIG. 6B. In some embodiments, before the electronic device is at the first location, in accordance with a determination that the electronic device is further than the threshold distance away from the first location, the electronic device forgoes activation of the one or more image capture devices for performance of recognition of objects, such as cameras 602 not being activated while the electronic device 101 is at its location in FIG. 6A and/or such as cameras 602 not being activated while the electronic device 101 is at its location in FIG. 6H. As such, in some embodiments, the electronic device toggles activation of the cameras for performance of recognition of objects when the current location of the electronic device is within the threshold distance described above. For example, the cameras are optionally not being used for performing recognition of objects until the electronic device is within the threshold distance. Performance of recognition of objects is further described with reference to method 700. Toggling activation of cameras for performance of recognition of objects when the current location of the electronic device is within the threshold distance conserves computing resources which makes the electronic device more efficient when being used to navigate to a destination.

In some embodiments, the one or more criteria includes a criterion that is satisfied based on content (e.g., one or more recognized objects) included in a field of view of the one or more image capture devices (e.g., when the recognized object is in a field of view of the cameras), such as when mailbox 608 in FIG. 6C is in the field of view of the cameras 602. For example, if a first recognized is not in the field of view of the cameras, then a navigation instruction relative to the first recognized object is not presented, and if the first recognized object is in the field of view then the navigation instruction relative to the first recognized object is optionally presented. In some embodiments, if the content in the field of view of the cameras is first content, the criterion is not satisfied, and if the content in the field of view of the cameras is second content, different from the first content, the criterion is satisfied. As such, in some embodiments, the navigation instruction is presented relative to an object that is in the field of view of the cameras and/or in the perspective of the user of the electronic device, such as described with reference to method 700. Presenting navigation instructions that are based on content in the field of view of the cameras enhances computer-assisted navigation because the content in the field of view of the camera may include the most-updated information and because the recognized objects in the content can be used by the navigation system to navigate the electronic device, which makes the electronic device more efficient when being used to navigate to a destination.

In some embodiments, while the electronic device is at a first respective location, in accordance with a determination that the one or more image capture devices capture images in a first direction that include a respective recognized object in the field of view of the one or more image capture devices, the electronic device presents a respective navigation instruction based on the image data from the one or more image capture devices, such as the cameras 602 capturing images in a direction that includes mailbox 608 and the electronic device 101 presenting navigation instruction 612a in FIG. 6C. In some embodiments, while the electronic device is at the first respective location, in accordance with a determination that the one or more image capture devices capture images in a second direction that do not include a recognized object in the field of view of the one or more image capture devices, the electronic device forgoes (and/or delays) presenting a navigation instruction based on the image data from the one or more image capture devices, such as shown with the electronic device 101 not presenting navigation instruction 612a in FIG. 6D. In some embodiments, the direction that the cameras face follows the direction that the user of the electronic device faces. For example, if the user is facing a first direction at the first respective location, then the cameras optionally face a direction that is based on the first direction (e.g., the cameras face the first direction or another direction that is based on the first direction), and if the user is facing a second direction at the first respective location, different from the first direction, then the cameras optionally face a direction that is based on the user facing the second direction (e.g., the cameras face the second direction or another direction that is based on the second direction), and the direction that is based on the user facing the second direction is different from the direction that is based on the user facing the first direction. As such, navigation instructions are optionally presented or not based on whether a recognized object is in the image data detected by the cameras, which is optionally based on whether the cameras are facing a direction that includes a recognized object in a field of view of the cameras. In some embodiments, were the user to face the first direction (e.g., turn to face the first direction) after facing the second direction while still being at the first respective location, the electronic device would, in response, present the navigation instruction. Presenting navigation instructions that are based on content that is the field of view of the cameras based on the direction that the cameras are facing further enhances computer-assisted navigation because whether a navigation instruction is presented or not respects the direction that the cameras face at the location of the electronic device, which makes the electronic device more efficient when being used to navigate to a destination.

In some embodiments, the electronic device is in communication with a global positioning system (GPS) while the navigation mode for navigating the electronic device from the first location to the second location is active, and while the electronic device is at the first respective location, in accordance with the determination that the one or more image capture devices capture images in the second direction that do not include a recognized object in the field of view of the one or more image capture devices, the electronic device presents, via the one or more output devices, a navigation instruction that is based on GPS data and that is not based on the data from the one or more image capture devices. For example, the electronic device 101 optionally presents navigation instruction 612c based on GPS data and not based on data from the cameras 602 in FIG. 6H. As another example, were the electronic device 101 to capture images that do not include the mailbox 608 or the flowers 614 while the electronic device 101 is on segment 605 and approaching segment 607 from FIGS. 6B-6F, the electronic device 101 would optionally present a navigation instruction that is based on GPS data and that is not based on the image data, such as a navigation instruction that indicates to make a left up ahead in 10 m at the T intersection, without identifying a recognized object in the navigation instruction. In some embodiments, if no recognized object is identified in the image data detected while the electronic device is at the first respective location, then the optionally presents a GPS-only navigation instruction, such as described with reference to method 700. In some embodiments, the GPS-only navigation instruction is presented after a threshold amount of time (e.g., 5 s, 10 s, 15, 45 s, 1 min, 2 min, or another threshold amount of time) is past since the electronic device has been within a threshold distance (e.g., 0.5 m, 1 m, 2 m, 5 m, 10 m, or 20 m, 25 m, 50 m, or another threshold distance) of a different segment of a route to the second location, such as described with reference to embodiment(s) of method 700. For example, when the electronic device enters the range (e.g., when the user walks within 150 ft of a turn to be made at intersection), the cameras are optionally detecting image data, and if no recognized object is in the image data, and the threshold amount of time has been reached since the electronic device has entered the range and/or the electronic device is further moved to being located within a second range less than first range of different segment (e.g., the turn), then the electronic device optionally presents the GPS-only navigation instruction. Presenting the GPS-only navigation instruction confirms to the user that the navigation mode is active even when no recognized object is detected in image data and maintains navigational features of the electronic device, makes navigating more efficient, and reduces errors when navigating to a destination using the electronic device.

In some embodiments, after the electronic device has moved from the first respective location to a second respective location, different from the first respective location, and after the determination that the one or more image capture devices capture images in the second direction that do not include a recognized object in the field of view of the one or more image capture devices while the electronic device is at the first respective location while the electronic device is at the second respective location, in accordance with a determination that the one or more image capture devices capture images in a first respective direction that include a recognized object in the field of view of the one or more image capture devices, the electronic device presents, via the one or more output devices, a respective navigation instruction based on the image data from the one or more image capture devices. For example, were the electronic device 101 to capture images that do not include the mailbox 608 or the flowers 614 while the electronic device 101 is on segment 605 and approaching segment 607 in FIGS. 6B-6D, and then capture images that includes the mailbox 608 as in FIG. 6E, then the electronic device 101 optionally presents navigation instruction 612a at its location in FIG. 6E. In some embodiments, after the electronic device has moved from the first respective location to a second respective location, different from the first respective location, and after the determination that the one or more image capture devices capture images in the second direction that do not include a recognized object in the field of view of the one or more image capture devices while the electronic device is at the first respective location while the electronic device is at the second respective location, in accordance with a determination that the one or more image capture devices capture images in a second respective direction that do not include a recognized object in the field of view of the one or more image capture devices, the electronic device forgoes presenting the navigation instruction based on the image data from the one or more image capture devices, such as the electronic device 101 forgoing presentation of navigation instruction 612a in FIGS. 6C and 6E. Thus, the image-based navigation instruction (e.g., a navigation instruction that is relative to a recognized object based on the image data from the cameras) is optionally presented when the recognized object is in the field of view of the cameras, which is optionally based on the direction that the cameras are capturing images at the respective location. In some embodiments, a navigation instruction that is relative to the same object would optionally be presented at different times and optionally with different characteristics (e.g., identifying a different distance until the maneuver that is to be completed at the same recognized object or identifying a different maneuver that is to be completed at the same recognized object) based on when that object is in the field of view of the cameras and on the difference in the relative positioning of that object in the field of view of the cameras. In some embodiments, the image-based navigation instruction that is presented at the second respective location identifies a different recognized object than the recognized object that would be identified in an image-based navigation instruction that would be presented at the first respective location if the camera were capturing images in the first direction that include a respective recognized object in the field of view of the cameras. Presenting image-based navigation instructions later when a recognized object is in the field of view of the cameras maintains consistency of image-based navigation instructions being presented in accordance with a recognized object is in the field of view of the cameras, and reduces errors when using the electronic device to navigate to a destination.

In some embodiments, the one or more criteria includes a criterion that is satisfied based on a distance between the electronic device and the recognized object, such as the electronic device 101 capturing images that include mailbox 608 in FIG. 6A, but not presenting navigation instruction 612a until the electronic device 101 is at its location in FIG. 6C due at least in part to a distance between the electronic device 101 and the mailbox 608 in FIG. 6A being greater than a threshold distance and the distance between the electronic device 101 and the mailbox in FIG. 6C being less than a threshold distance. For example, when the distance is a first distance (e.g., 10, 20, 30, 40 m, or another distance), the navigation instruction is optionally not presented (e.g., optionally even if the recognized object is in the field of view of the cameras), and when the distance is a second distance, less than the first distance, the navigation instruction is optionally presented. In some embodiments, the electronic device measures the distance using one or more distance measuring systems that involve the current location of the electronic device and/or image data captured by the cameras. Presenting the navigation instruction relative to the recognized object based on the distance between the electronic device and the recognized object reduces a risk of the electronic device providing a navigation instruction relative to an object that the user of the electronic device cannot see (e.g., due to visual acuity of the user's eyes being different from that of the cameras), makes the user's navigation experience more desirable, and reduces errors when using the electronic device to navigate to a destination.

In some embodiments, the one or more criteria includes a criterion that is satisfied based on an amount of time since a previous navigation instruction was presented via the one or more output devices, such as navigation instruction 612c in FIG. 6H being presented due to the amount of time since a previous navigation instruction was presented satisfying the criterion. For example, when the amount of time is a first amount of time (e.g., 1 s, 5 s, 10 s, 20 s, or another amount of time), the navigation instruction is optionally not presented, and when the amount of time is a second amount of time (e.g., 5 s, 10 s, 30 s, 1 min, or another amount of time) greater than the first amount of time, the navigation instruction is optionally presented. In some embodiments, the previous navigation instruction is the latest presented navigation instruction. In some embodiments, if the electronic device is moved away from a route that the electronic device recommends then the timing criteria is optionally overridden such that the electronic device would present an image-based navigation instruction even if the first amount of time since the previously presented navigation instruction has not yet past. Presenting the navigation instruction relative to the recognized object based on an amount of time that has elapsed since a previous navigation instruction has been presented conserves computing resources devoted to presenting navigation instructions since a threshold amount of time has to be reached before the electronic device presents a next navigation instruction, makes the user's navigation experience more desirable since the user is not bombarded with different navigation instructions back-to-back, and reduces errors when using the electronic device to navigate to a destination.

In some embodiments, while a respective recognized object is in a field of view of the image capture devices, the electronic device detects, via the one or more image capture devices, image data that includes the respective recognized object, such as potted plant 626 in FIG. 6M. In some embodiments, after detecting the image data that includes the respective recognized object and while the respective recognized object is not in the field of view of the image capture devices, the electronic device presents, via the one or more output devices, a first navigation instruction relative to the respective recognized object, such as navigation instruction 612i in FIG. 6P. As such, in some embodiments, the electronic device presents navigation directions that are relative to an object that was previously in the field of view of the cameras and that is no longer in the field of view. In some embodiments, the first navigation instruction is presented after a period of time (e.g., 30 s, 1 min, 5 min, 20 min, 1 hr, or another period of time) of the respective recognized object being in the field of view of the cameras. In some embodiments, when the first navigation instruction is presented, one or more objects different from the third object are in the field of view of the cameras or no recognized objects are in the field of view of the cameras. In some embodiments, the first navigation instruction is presented because a (next) segment of the route is not in the current field of view of the cameras when the first navigation instruction is presented. In some embodiments, the first navigation instruction is presented because a (next) segment of the route is not in the current field of view of the cameras when the first navigation instruction is presented, even if one or more other objects are in the current field of view of the cameras when the first navigation instruction is presented. In some embodiments, the trigger for presenting the first navigation instruction is different from (e.g., is not) the respective recognized object being in the field of view of the cameras when the first navigation instruction is triggered and/or initiated to be presented. In some embodiments, the object was not in the field of view of the cameras when the navigation instruction of step(s) 802 was presented. For example, the object was in the field of view of the cameras before or after the first or second time of step(s) 802 but not at the first or second time. In some embodiments, the electronic device detects the object and presents the navigation instruction relative to the object while the navigation mode for navigating the electronic device from the first location to the second location is active. In some embodiments, the electronic device detects the object while navigating from the first to the second location (e.g., a destination of the navigation), but presents the navigation instruction relative to the object while navigating to a different destination than the second location. For example, the electronic device optionally detects the object while navigating to the second location, and then, optionally after reaching the second location (e.g., the destination of the navigation) or after exiting the navigation mode, the electronic device enters the navigation mode again but for routing to a third location. Continuing with this example, the electronic device optionally presents the navigation instruction relative to the object that was detected while the navigation mode for navigating the electronic device from the first location to the second location was active. Thus, in some embodiments, the electronic device stores data (e.g., image data) corresponding to the object that was in the field of view of the cameras and optionally presents a navigation instruction relative to that object while that object is no longer in the field of view of the cameras. For example, the electronic device optionally generates and maintains a mapping of objects that were in a field of view of the cameras, and can later using such mapping for navigating even if the objects are not in the field of view of the cameras when the electronic device presents a navigation instruction relative to one of those objects. Such features make navigating to the second location more efficient, such as when the object would likely be remembered by the user of the user of the electronic device. For example, the navigation instruction optionally include navigating into a room through a door, and the electronic device optionally maintains data corresponding to characteristics of the door (e.g., where the door is located relative to the room and that the electronic device entered the door in order to get into the room) and can use such information later, such as by presenting a navigation instruction relative to the door while the door is not in the field of view of the cameras when it is presented. Presenting navigation instructions relative to previously recognized objects that are no longer in a field of view of the cameras makes navigating more efficient because the system can navigate using previously recognized objects in addition to recognized objects that are in the field of view of the cameras, which altogether enhances navigating, and reduces errors when using the electronic device to navigate to a destination.

In some embodiments, when the electronic device is at a first determined location, the electronic device presents, via the one or more output devices, a particular navigation instruction. In some embodiments, presenting, via the one or more output devices, the particular navigation instruction includes in accordance with a determination that a respective recognized object was in a field of view of the one or more image capture devices before the electronic device is at the first determined location, and that a second respective recognized object was not in the field of view of the one or more image capture devices before the electronic device is at the first determined location, presenting, via the one or more output devices, a first navigation instruction for navigating to the second location. For example, were the mailbox 608 in the field of view of the cameras 602 without the flowers 614 being in the field of view before the electronic device 101 is at its location in FIG. 6C, the electronic device 101 optionally presents navigation instruction 612a of FIG. 6C. The first navigation instruction is optionally relative to the recognized object of step(s) 802 or to a different recognized object. Thus, in some embodiments, the first navigation instruction is different depending on which object was in the field of view of the image capture devices before the electronic device is at the first determined location. In some embodiments, presenting, via the one or more output devices, the particular navigation instruction includes in accordance with a determination that the second respective recognized object was in the field of view of the one or more image capture devices before the electronic device is at the first determined location, and that the first respective recognized object was not in the field of view of the one or more image capture devices before the electronic device is at the first determined location, presenting, via the one or more output devices, a second navigation instruction for navigating to the second location, different from the first navigation instruction for navigating to the second location. For example, were the flowers 614 in the field of view of the cameras 602 without the mailbox 608 being in the field of view of the cameras 602 before the electronic device 101 is at its location in FIG. 6F, which is the same location as in FIG. 6C, the electronic device 101 optionally presents navigation instruction 612b of FIG. 6F. The second navigation instruction is optionally relative to the recognized object of step(s) 802 or to a different recognized object. Thus, in some embodiments, the particular navigation instruction is different depending on which object was in the field of view of the image capture devices before the electronic device is at the first determined location. In some embodiments, the electronic device provides different directions depending on what was captured in the field of view of the cameras up to the point of navigation to the current location of the electronic device. In some embodiments, the criteria for causing or initiating presentation of the particular navigation instruction as the first navigation instruction or the second navigation instruction is the same (e.g., the trigger for presenting the first or second navigation instruction is the same), but the navigation instruction that is presented is different based on differences in content that has been in the field of view of the cameras up to (e.g., prior to) satisfaction of the trigger. For example, if while traveling up to the current location of the electronic device the cameras captured images including a parked bicycle, then the electronic device would optionally have presented a navigation instruction relative to the bicycle, and if the cameras captured images that do not include the bicycle but included a skateboard, the electronic device would optionally present navigation instructions relative to the skateboard, without ever presenting a navigation instruction relative to the bicycle since the cameras in this case never captured images that included the bicycle. As another example, if while traveling up to the current location of the electronic device the cameras captured images including a stroller, then the electronic device would optionally have presented a navigation instruction relative to the stroller, and if the cameras captured images that do not include the stroller but included table, the electronic device would optionally present navigation instructions relative to the table, without ever presenting a navigation instruction relative to the stroller since the cameras in this case never captured images that included the stroller. As such, in some embodiments, the electronic device provides different directions depending upon differences in content captured by the cameras (e.g., such as do to the camera being posed differently (e.g., facing different directions) at different times while navigating to the current location of the electronic device. Presenting different navigation instructions at a first current location of the electronic device based on which objects were in the field of view of the cameras before the electronic device is at the first current location contextualizes the navigation instructions to what is in the field of view of the cameras and reduces errors when using the electronic device to navigate to a destination.

In some embodiments, the electronic device is at a first determined location when the navigation instruction is presented, the navigation instruction includes instructions for proceeding to a next segment of a route that is to the second location, and the first determined location is part of a current segment of the route, prior to the next segment of the route, such as shown with navigation instruction 612a in FIG. 6C including instructions for proceeding from first segment 605 to segment 607. In some embodiments, the next segment of the route to the second location is a street, walkway, or another type of path or terrain, that is optionally somewhere along the route in between the first and the second location. In some embodiments, the instructions for proceeding to the next segment include instructions to turn left or right at the recognized object, go into recognized object, go beside (e.g., walk beside) the recognized object, and/or another instruction relative to the recognized object. In some embodiments, if the electronic device is in a different segment of the route, the electronic device provides a different navigation instruction at the first determined location, though still a navigation instruction for proceeding to the next segment (e.g., that navigation instruction may have different characteristics based on the maneuver to make from the prior segment of the route to get to the next segment of the route). In some embodiments, the current segment and the next segment of the route are separated by a maneuver (e.g., a turn or another maneuver). For example, to get to the next segment in accordance with the instructions from the current segment the electronic device (and/or the user) optionally has to make and/or complete the maneuver (e.g., turning right, turning left, turning around, continuing straight, taking the right fork, taking the left fork, etc.) between the segments. Additional descriptions of examples and/or alternative embodiments are described with reference to method 700. Presenting navigation instructions, relative to recognized objects, suggestive of how to proceed to a next segment of a route timely notifies the user that a next segment of the route is upcoming, which reduces errors when using the electronic device to navigate to a destination.

In some embodiments, the navigation instruction includes an indication of a location of a waypoint of a route that is to the second location, such as shown with navigation instruction 612f in FIG. 6K. For example, the waypoint is optionally a starting point, intermediate point (e.g., a point in between the starting point and the ending point), and/or an ending point of the route. For example, a car is parked to the right of a location of a waypoint, the car is in the field of view of the cameras, and the first navigation instruction optionally indicates (e.g., verbally indicates) that a waypoint on the way to the user's destination is next to the car on the right. For example, a car is parked next to the second location, and the first navigation instruction optionally identifies a location of the destination being relative to a recognized object of a car that is in the field of view of the cameras (e.g., the first navigation instruction optionally indicates (e.g., verbally indicates) the user's destination as being next to (e.g., to the right of) the parked car. As such, in some embodiments, the electronic device presents indications of locations of waypoints in the presentation of navigation instructions, such as described above and/or with reference to method 700. Presenting navigation instructions, relative to recognized objects, suggestive of locations of waypoints timely notifies the user of the waypoints, which can indicate an amount of progress that has been made on the route to the second location and/or that is still to be made on the route to the second location and reduces errors when using the electronic device to navigate to a destination.

In some embodiments, the one or more image capture devices are being worn by a user of the electronic device, such as cameras 602 being worn by user 102 in FIG. 6A. For example, the cameras are optionally worn on a portion of the user's body, such as on a head, ears, wrists, arms, or another portion of the user. In some embodiments, at a location of the user in an environment, the cameras face the direction that the head of the user faces so that the camera can capture image data that overlap with the field of view of the user Further details of the cameras being worn by the user are described with reference to method 700. Configuring the cameras to be worn of the user of the electronic device allows for real-time image detection that is based on the current location of the user of the electronic device and reduces errors when using the electronic device to navigate to a destination.

In some embodiments, the one or more image capture devices and the one or more output devices are included in a same device, such as cameras 602 and headphones 604 in FIG. 6A being included in the same device. For example, the cameras are optionally included in headphones and/or earphones devices, and the headphones and/or earphones devices are optionally configured to present audio of the navigation instructions. As another example, the cameras are included in an AR/VR pair of glasses, and the AR/VR glasses are optionally configured to present audio and/or visual navigation instructions. For example, the cameras and the presentation devices are optionally worn on a portion of the user's body, such as on a head, ears, wrists, arms, or another portion of the user, and are optionally part of the same device, such as a head-mounted device, an extended reality device (e.g., an augmented reality/virtual reality device, or another type of extended reality device). In some embodiments, the cameras and the presentation devices are worn on the same portion of the user. In some embodiments, the cameras are worn on a first portion of the user and the presentation devices are worn on a second portion of the user that is different from the first portion of the user. Additional descriptions of examples and/or alternative embodiments of the camera and output devices being in the same device are described with reference to method 700. Including the cameras and presentation devices in the same device that is to be worn of the user allows for real-time image detection and navigation instruction presentation that is based on the current location of the user of the electronic device and reduces errors when using the electronic device to navigate to a destination.

In some embodiments, while the navigation mode for navigating the electronic device from the first location to the second location is active, and while the electronic device is at a first determined location, in accordance with a determination that one or more second criteria are satisfied, including a criterion that is satisfied when recognition of objects in the image data detected by the one or more image capture devices is not performed (e.g., is not being performed or is being performed but no recognized object is detected), the electronic device presents, via the one or more output devices, a respective navigation instruction that is not based on the image data detected by the one or more image capture devices, such as navigation instruction 612d in FIG. 6I. In some embodiments, the criteria are satisfied after a threshold amount of time (e.g., 10 s, 15, 45 s, 1 min, 2 min, or another threshold amount of time) has passed while the cameras are detecting image data but no recognized object is in the image data. The respective navigation instruction is optionally based on location data (e.g., data about the location of the electronic device and/or about the orientation of the electronic device, such as GPS data, image-based location data, or other location data) without being based on image data. For example, the electronic device optionally provides navigation instructions that are independent of the image data detected by the cameras when no object is being recognized in the image data detected by the cameras (e.g., when neither the first or second recognized object is detected). Continuing with this example, the navigation instructions are optionally based on GPS, without being based on the image data from the cameras (e.g., without including or identifying an object that would not typically be provided in a GPS-only navigation). Additional descriptions of examples and/or alternative embodiments are described with reference to method 700. Still presenting a navigation instruction when recognizing of objects in the image data is not being performed allows the navigation mode to still navigate the user even when recognizing of objects in the image data is not being performed, confirms to the user that the navigation mode is active and working, and reduces errors when using the electronic device to navigate to a destination.

In some embodiments, while the navigation mode for navigating the electronic device from the first location to the second location is active, in accordance with a determination that the electronic device is at a first respective location while the navigation mode for navigating the electronic device from the first location to the second location is active, the electronic device forgoes performance of recognizing objects in detected image data via the one or more image capture devices, such as shown with the electronic device 101 not performing recognizing of objects in detected image data while the electronic device 101 is in second segment 632 in FIG. 6Q. In some embodiments, while the navigation mode for navigating the electronic device from the first location to the second location is active, in accordance with a determination that the electronic device is at a second respective location, different from the first respective location, while the navigation mode for navigating the electronic device from the first location to the second location is active, the electronic device performs recognizing objects in detected image data via the one or more image capture devices, such as shown with the electronic device 101 performing recognizing of objects in detected image data while the electronic device 101 is in first segment 630 in FIG. 6Q. As such, the electronic device optionally toggles performance of recognizing objects in detected image data detected via the cameras based on a location of the electronic device while the navigation mode is active, such as described with reference to method 700. In some embodiments, when the performance of recognizing objects is inactive, the cameras are active or inactive. In some embodiments, when the performance of recognizing objects is active, the cameras are active. Toggling image processing based on location data conserves computing resource usage at the electronic device and makes navigating more efficient.

In some embodiments, while the navigation mode for navigating the electronic device from the first location to the second location is active, in accordance with a determination that a current mode of transport is a first mode of transport to the second location (e.g., via a boat, a car, a train, a subway train, a bus, or another mode of transport), the electronic device forgoes performance of recognizing objects in detected image data via the one or more image capture devices, such as shown with the electronic device 101 not performing recognizing of objects in detected image data while the electronic device 101 is in second segment 632 in FIG. 6Q, which involves a first mode of transport. In some embodiments, while the navigation mode for navigating the electronic device from the first location to the second location is active, in accordance with a determination that the current mode of transport is a second mode of transport (e.g., via a bike, a walk of a user of the electronic device, or another mode of transport), different from the first mode of transport, to the second location, the electronic device performs recognizing objects in detected image data via the one or more image capture devices, such as shown with the electronic device 101 performing recognizing of objects in detected image data while the electronic device 101 is in first segment 630 in FIG. 6Q, which involves a second mode of transport different from the mode of transport associated with second segment 632. As such, the electronic device optionally toggles performance of recognizing objects in detected image data detected via the cameras based on a current mode of transport of the electronic device while the navigation mode is active, such as described with reference to method 700. In some embodiments, when the performance of recognizing objects is inactive, the cameras are active or inactive. In some embodiments, when the performance of recognizing objects is active, the cameras are active. In some embodiments, navigating to from the first to the second location includes navigating using different modes of transport, and the electronic device toggles performance of recognizing objects in detected image data based on the current location of the electronic device relative to the mode of transport. For example, for a first portion of the route to the second location, the electronic device is being transported by walking of the user (e.g., the user of the electronic device walking in a walkway), and the recognizing of objects in detected image data is performed while the electronic device is located in the first portion of the route to the second location, and in a second portion of the route to the second location, different from the first portion, the electronic device is being transported by a subway train (e.g., the user of the electronic device is on a subway train), and the recognizing of objects in detected image data is not performed while the electronic device is located in the second portion of the route to the second location. In some embodiments, the electronic device performs different modes of image recognition based on the mode of transport of the electronic device. For example, the electronic device is optionally configured to perform image recognition in a first mode of transport that involves walking of the user of the electronic device and in a second mode of transport of that involves biking of the user. Continuing with this example, even if the cameras detect the same image data in each mode of transport, the navigation instructions that are presented relative to objects are optionally relative to different objects. That is, one or more or all objects that were used in navigation instructions in the first mode of transport (e.g., the walking of the user) would optionally be different from one or more or all objects that were used in navigation instructions in the second mode of transport (e.g., the biking of the user). In some embodiments, a mode of transport of the electronic device is determined based on the mode of transport permitted on and/or defined by the current segment of the route (e.g., defined by the navigation directions and/or the determined navigation route). Additionally or alternatively, in some embodiments, the mode of transport is determined based on performance of recognizing objects in detected image data captured from the cameras. Additionally or alternatively, in some embodiments, the mode of transport is determined based on motion (e.g., a speed of movement) detected by the electronic device (e.g., by sensors of the electronic device). Toggling image processing based on a mode of transport conserves computing resource usage at the electronic device and makes navigating more efficient.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 800 described above with respect to FIG. 8. For example, the operation of the navigation instruction described above with reference to method 800 optionally has one or more of the characteristics of presenting the first navigation instruction described herein with reference to other methods described herein (e.g., method 700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations and/or steps described above with reference to FIG. 8 are, optionally, implemented by components depicted in FIGS. 1A-1B. For example, presenting steps 802b and 802d, and forgoing presenting step 802c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, TWITTER ID's, home addresses, data relating to a person's likeness, name, date of birth, or any other identifying or personal information.

The present disclosure recognizes that the use of such personal information data, in the present technology, can be used to the benefit of users. For example, utilizing location-based data helps the electronic device to navigate the user more efficiently. Accordingly, use of such personal information data enables users to use electronic devices to perform enhanced navigation operations. Further, other uses for personal information data that benefit the user are also contemplated by the present disclosure. For instance, the electronic device may present navigation instruction relative to objects based on distance between the electronic device and the object, and further based on whether the object would be seen by the user provided the electronic device is aware of the eye characteristics of the particular user.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device generated generative visual media content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more input devices, including one or more image capture devices, and one or more output devices:
while a navigation mode for navigating the electronic device from a first location to a second location is active, and while the electronic device is at a first determined location, detecting image data via the one or more image capture devices, wherein the one or more image capture devices are at the first determined location; and
in response to detecting the image data via the one or more image capture devices:
in accordance with a determination that the image data includes a first recognized object and not a second recognized object, presenting, via the one or more output devices, a first navigation instruction, the first navigation instruction being relative to the first recognized object for navigating to the second location; and
in accordance with a determination that the image data includes a second recognized object and not the first recognized object, presenting, via the one or more output devices, a second navigation instruction, different from the first navigation instruction, the second navigation instruction being relative to the second recognized object for navigating to the second location, different from the first navigation instruction relative to the first recognized object for navigating to the second location.

2. The method of claim 1, wherein the first recognized object is not an official traffic-orienting object, and wherein the second recognized object is not an official traffic-orienting object.

3. The method of claim 1, wherein:
the determination that the image data includes the first recognized object and not the second recognized object includes a determination that the first recognized object includes one or more characteristics of a set of objects in an image recognition system in communication with the electronic device while the electronic device is in the navigation mode; and
the determination that the image data includes the second recognized object and not the first recognized object includes a determination that the second recognized object includes one or more characteristics of the set of objects in the image recognition system in communication with the electronic device while the electronic device is in the navigation mode.

4. The method of claim 1, wherein the first navigation instruction relative to the first recognized object for navigating to the second location includes direction information relative to the first recognized object.

5. The method of claim 4, wherein the direction information relative to the first recognized object is to the right of, to the left of, above, below, through, or another direction relative to the first recognized object.

6. The method of claim 1, wherein:
presenting, via the one or more output devices, the first navigation instruction relative to the first recognized object for navigating to the second location is also in accordance with a determination that a user of the electronic device is facing a first direction at the first determined location and a determination that a perspective of the user includes the first recognized object; and
presenting, via the one or more output devices, the second navigation instruction relative to the second recognized object for navigating to the second location is also in accordance with a determination that the user of the electronic device is facing a second direction, different from the first direction, at the first determined location and a determination that a perspective of the user includes the second recognized object.

7. The method of claim 1, wherein the one or more output devices includes one or more audio output devices and wherein presenting, via the one or more output devices, the first navigation instruction relative to the first recognized object for navigating to the second location includes presenting, via the one or more audio output devices, one or more first audio components as spatialized audio.

8. The method of claim 7, wherein the first recognized object is at a first respective location, and wherein the one or more first audio components are presented as emanating from the first respective location.

9. The method of claim 7, wherein the first recognized object is at a first respective location, wherein the first navigation instruction relative to the first recognized object for navigating to the second location includes an instruction corresponding to a first navigation maneuver to be completed at a first respective spatial relationship relative to the first recognized object, and wherein the one or more first audio components are presented as emanating from a location that is offset from the first respective location and has the first respective spatial relationship relative to the first respective location.

10. The method of claim 1, comprising while the navigation mode for navigating the electronic device from the first location to the second location is active, presenting, via the one or more output devices, a third navigation instruction that confirms that a user of the electronic device is navigating to the second location.

11. The method of claim 1, comprising:
while a third recognized object is in a field of view of the one or more image capture devices, detecting, via the one or more image capture devices, image data that includes the third recognized object; and
after detecting the image data that includes the third recognized object and while the third recognized object is not in the field of view of the one or more image capture devices, presenting, via the one or more output devices, a third navigation instruction relative to the third recognized object.

12. The method of claim 1, wherein presenting, via the one or more output devices, the first navigation instruction includes:
in accordance with a determination that a third recognized object was in a field of view of the one or more image capture devices before the electronic device is at the first determined location, and that a fourth recognized object was not in the field of view of the one or more image capture devices before the electronic device is at the first determined location, presenting, via the one or more output devices, a third navigation instruction for navigating to the second location; and
in accordance with a determination that the fourth recognized object was in the field of view of the one or more image capture devices before the electronic device is at the first determined location, and that the third recognized object was not in the field of view of the one or more image capture devices before the electronic device is at the first determined location, presenting, via the one or more output devices, a fourth navigation instruction for navigating to the second location.

13. The method of claim 1, wherein the first navigation instruction includes instructions for proceeding to a next segment of a route that is to the second location, and wherein the first determined location is part of a current segment of the route, prior to the next segment of the route.

14. The method of claim 1, wherein the first navigation instruction includes an indication of a location of a waypoint of a route that is to the second location.

15. The method of claim 1, wherein the one or more image capture devices are being worn by a user of the electronic device.

16. The method of claim 15, wherein the one or more image capture devices and the one or more output devices are included in a same device.

17. The method of claim 1, comprising:
while the navigation mode for navigating the electronic device from the first location to the second location is active, and while the electronic device is at the first determined location, in accordance with a determination that one or more criteria are satisfied, including a criterion that is satisfied when recognition of objects in the image data detected by the one or more image capture devices is not performed, presenting, via the one or more output devices, a respective navigation instruction that is not based on the image data detected by the one or more image capture devices.

18. The method of claim 1, comprising:
while the navigation mode for navigating the electronic device from the first location to the second location is active:
in accordance with a determination that the electronic device is at a first respective location while the navigation mode for navigating the electronic device from the first location to the second location is active, forgoing performance of recognizing objects in detected image data via the one or more image capture devices; and
in accordance with a determination that the electronic device is at a second respective location, different from the first respective location, while the navigation mode for navigating the electronic device from the first location to the second location is active, performing recognizing objects in detected image data via the one or more image capture devices.

19. The method of claim 1, comprising:
while the navigation mode for navigating the electronic device from the first location to the second location is active:
in accordance with a determination that the electronic device is in a first mode of transport to the second location while the navigation mode for navigating the electronic device from the first location to the second location is active, forgoing performance of recognizing objects in detected image data via the one or more image capture devices; and
in accordance with a determination that the electronic device is in a second mode of transport, different from the first mode of transport, to the second location, while the navigation mode for navigating the electronic device from the first location to the second location is active, performing recognizing objects in detected image data via the one or more image capture devices.

20. An electronic device that is in communication with one or more input devices, including one or more image capture devices, and one or more output devices, the electronic device comprising:
one or more processors;
memory; and
one or more programs, wherein the one or more programs are stored in the memory and are configured to be executed by the one or more processors, the one or more programs including instructions for:
while a navigation mode for navigating the electronic device from a first location to a second location is active, and while the electronic device is at a first determined location, detecting image data via the one or more image capture devices, wherein the one or more image capture devices are at the first determined location; and
in response to detecting the image data via the one or more image capture devices:
in accordance with a determination that the image data includes a first recognized object and not a second recognized object, presenting, via the one or more output devices, a first navigation instruction, the first navigation instruction being relative to the first recognized object for navigating to the second location; and
in accordance with a determination that the image data includes a second recognized object and not the first recognized object, presenting, via the one or more output devices, a second navigation instruction, different from the first navigation instruction, the second navigation instruction being relative to the second recognized object for navigating to the second location, different from the first navigation instruction relative to the first recognized object for navigating to the second location.

21. A non-transitory computer readable storage medium storing one or more programs, the one or more programs comprising instructions, which when executed by one or more processors of an electronic device that is in communication with one or more input devices, including one or more image capture devices, and one or more output devices, cause the electronic device to perform a method comprising:
while a navigation mode for navigating the electronic device from a first location to a second location is active, and while the electronic device is at a first determined location, detecting image data via the one or more image capture devices, wherein the one or more image capture devices are at the first determined location; and
in response to detecting the image data via the one or more image capture devices:
in accordance with a determination that the image data includes a first recognized object and not a second recognized object, presenting, via the one or more output devices, a first navigation instruction, the first navigation instruction being relative to the first recognized object for navigating to the second location; and
in accordance with a determination that the image data includes a second recognized object and not the first recognized object, presenting, via the one or more output devices, a second navigation instruction, different from the first navigation instruction, the second navigation instruction being relative to the second recognized object for navigating to the second location, different from the first navigation instruction relative to the first recognized object for navigating to the second location.

22-50. (canceled)
